(19) United States
(12) Patent Application Publication
(10) Pub. No.: US 2026/0310058 A1
(43) Pub. Date: Oct. 8, 2026

(54) LIGHT SOURCE DEVICE AND IMAGE DISPLAY DEVICE

(71) Applicant: SONY SEMICONDUCTOR SOLUTIONS CORPORATION, Kanagawa (JP)

(72) Inventor: Kentaro HARASE, Kanagawa (JP)

(73) Assignee: SONY SEMICONDUCTOR SOLUTIONS CORPORATION, Kanagawa (JP)

(21) Appl. No.: 18/880,643

(22) PCT Filed: Jun. 2, 2023
(86) PCT No.: PCT/JP2023/020604

§ 371 Date: Jan. 2, 2025

(30) Foreign Application Priority Data
Jul. 11, 2022 (JP) 2022-111310

(51) Int. Cl. G03B 21/20; G03B 21/00

(52) U.S. Cl. CPC G03B 21/208; G03B 21/006; G03B 21/008; G03B 21/2013; G03B 21/2033

(57) ABSTRACT

A light source device comprises a light source and an optical system including a lens in an optical path of light from the light source. The lens has a numerical aperture of 0.16 or less and the light source has a radiation angle sum, which is defined as a sum of a first radiation angle measured with respect to a first direction and a second radiation angle measured with respect to a second direction orthogonal to the first direction.

### CROSS REFERENCE TO RELATED APPLICATIONS

This application claims the benefit of Japanese Priority Patent Application JP 2022-111310 filed on Jul. 11, 2022, the entire contents of which are incorporated herein by reference.

### TECHNICAL FIELD

The technology according to the present disclosure (hereinafter also referred to as “the present technology”) relates to a light source device and an image display device.

### BACKGROUND ART

In related art, a light source device that emits light from a light source via an optical system including a lens is known.

There is a light source device of related art in which a numerical aperture (NA) of a lens is increased in order to compensate for insufficiency of a light amount of a light source (for example, see PTL 1). To increase the numerical aperture (NA) of the lens as an approach to increase efficiency as described above has been widely known as normal optical design.

Meanwhile, there is a light source device of related art including an optical filter that adjusts (reduces) the amount of light from a light source (see, for example, PTL 2).

### CITATION LIST

### Patent Literature

PTL 1: JP 2017-3922A
PTL 2: JP H05-120724A

### SUMMARY

### Technical Problem

For example, PTL 1 does not mention any technique for coping with an excessive amount of light of the light source. For example, in PTL 2, an additional component such as an optical filter is used to cope with an excessive amount of light of the light source.

Therefore, a main object of the present technology is to provide a light source device capable of coping with an excessive amount of light of a light source without using an additional component such as an optical filter.

### Solution to Problem

The present technology provides a light source device including:
at least one light source; and
an optical system disposed on an optical path of light from the light source and including a lens,
the lens having a numerical aperture of 0.16 or less, and the light source having a radiation angle sum of 14° or more, the radiation angle sum being a sum of radiation angles respectively related to two directions orthogonal to each other.

The numerical aperture may be 0.09 or less, and the radiation angle sum may be 14° or more.

The numerical aperture may be 0.16 or less, and the radiation angle sum may be 23° or more.

The numerical aperture may be 0.09 or less, and the radiation angle sum may be 23° or more.

The lens may be a spherical lens or an aspherical lens.

The light source may be a semiconductor laser.

The present technology provides an image display device including:
the light source device;
an image forming unit that forms an image with light from the light source device; and
a projection optical system that projects the light forming the image.

The image forming unit may include an optical deflector.

The image forming unit may include a digital mirror device.

The image forming unit may include a liquid crystal element.

The at least one light source may be a plurality of the light sources having different light emission wavelengths, a plurality of the lenses may be provided to correspond to the plurality of light sources, and the optical system of the light source device may combine beams of light respectively emitted from the plurality of light sources and passing through the corresponding lenses.

The at least one light source may be a plurality of the light sources having different light emission wavelengths, a plurality of the lenses may be provided to correspond to the plurality of light sources, a plurality of the liquid crystal elements may be provided to correspond to the plurality of lenses, and the image forming unit may cause beams of light passing through the plurality of lenses to be incident on the liquid crystal elements corresponding to the lenses, respectively, and combine beams of light passing through the liquid crystal elements.

An optical element that guides light passing through the projection optical system to an eyeball of a user may be further provided.

The image forming apparatus may further include a condensing optical element disposed on the optical path of the light between the light source device and the image forming unit.

The image forming unit may include a digital mirror device, and the condensing optical element may condense the light on the optical path of the light between the light source device and the digital mirror device.

The image forming unit may include an optical deflector, and the condensing optical element may condense the light on the optical deflector.

The projection optical system may include a condensing optical element.

The projection optical system may include a projection optical element, and the condensing optical element may be disposed between the image forming unit and the projection optical element.

An optical element that guides light passing through the projection optical system to an eyeball of a user may be further provided, the projection optical system may include a projection optical element, and the condensing optical element may be disposed on the optical path of the light between the projection optical element and the optical element.

At least the optical element may be mounted on a head of the user.

### BRIEF DESCRIPTION OF DRAWINGS

FIG. 1 is a view for describing an image display device according to Comparative Example 1.

FIG. 2 is a view for describing an image display device according to Comparative Example 2.

FIG. 3 is a view for describing a definition of a radiation angle of a laser.

FIG. 4 is a view (Part 1) for describing a method for measuring a radiation angle of a laser.

FIG. 5 is a view (Part 2) for describing the method for measuring a radiation angle of a laser.

FIG. 6 is a view for describing a numerical aperture of a lens.

FIG. 7 is a view (Part 1) for describing a method for measuring a numerical aperture of a lens.

FIG. 8 is a view (Part 2) for describing the method for measuring a numerical aperture of a lens.

FIG. 9 is a view for describing an image display device according to Comparative Example 3.

FIG. 10 is a view (Part 1) for describing how to obtain efficiency.

FIG. 11 is a view (Part 2) for describing how to obtain efficiency.

FIG. 12 is a view for describing how to obtain efficiency of a lens having a small numerical aperture.

FIG. 13 is a view for describing a method for reducing a numerical aperture of a lens.

FIG. 14A is a view illustrating a light source device according to Comparative Example 4. FIG. 14B is a view illustrating Configuration Example 1 of a light source device according to the present technology.

FIG. 15A is a view illustrating an image display device according to Comparative Example 5. FIG. 15B is a view illustrating an image display device according to Comparative Example 6. FIG. 15C is a view illustrating Configuration Example 1 of an image display device according to the present technology.

FIG. 16A is a view illustrating an image display device according to Comparative Example 7. FIG. 16B is a view illustrating an image display device according to Comparative Example 8. FIG. 16C is a view illustrating Configuration Example 2 of the image display device according to the present technology.

FIG. 17 is a view illustrating an image display device according to Comparative Example 9.

FIGS. 18A and 18B are views for describing a principle of resolution enhancement.

FIG. 19 is a view (Part 1) illustrating a relationship among a radiation angle sum, a numerical aperture, and efficiency.

FIG. 20A is a view illustrating a relationship among a numerical aperture, a peripheral light amount ratio, and a projection light amount. FIG. 20B is a view illustrating a relationship between the numerical aperture and a volume ratio.

FIG. 21A is a view illustrating a relationship among a numerical aperture, adjustment sensitivity, and a projection light amount. FIG. 21B is a view illustrating a relationship among the numerical aperture and a light amount change due to adjustment, and the projection light amount.

FIG. 22 is a view (Part 2) illustrating the relationship among the radiation angle sum, the numerical aperture, and the efficiency.

FIG. 23 is a view illustrating a relationship between a numerical aperture and a light intensity distribution.

FIG. 24 is a view (Part 3) illustrating the relationship among the radiation angle sum, the numerical aperture, and the efficiency.

FIG. 25 is a view illustrating a positional relationship between a light source and a lens in each of a light source device of related art and the light source device of the present technology.

FIG. 26 is a view for describing adjustment sensitivity (in a case where a positional deviation and an angular deviation are small) of the light source device of related art.

FIG. 27 is a view for describing adjustment sensitivity (in a case where a positional deviation and an angular deviation are small) of the light source device of the present technology.

FIG. 28 is a view for describing adjustment sensitivity (in a case where the positional deviation and the angular deviation are large) of the light source device of related art.

FIG. 29 is a view for describing adjustment sensitivity (in a case where the positional deviation and the angular deviation are large) of the light source device of the present technology.

FIG. 30 is a view illustrating Configuration Example 3 of the image display device according to the present technology.

FIG. 31 is a block diagram illustrating functions of Configuration Example 3 of the image display device according to the present technology.

FIG. 32 is a view illustrating Configuration Example 4 of the image display device according to the present technology.

FIG. 33 is a view illustrating Configuration Example 5 of the image display device according to the present technology.

FIG. 34 is a view for comparing volumes of the light source device of related art and the light source device of the present technology.

FIG. 35 is a view illustrating an image display device according to a first embodiment of the present technology.

FIG. 36 is a view illustrating an image display device according to a second embodiment of the present technology.

FIG. 37 is a view illustrating an image display device according to a third embodiment of the present technology.

FIG. 38 is a view illustrating an image display device according to a fourth embodiment of the present technology.

FIG. 39 is a view illustrating an image display device according to a fifth embodiment of the present technology.

FIG. 40 is a view illustrating an image display device according to a sixth embodiment of the present technology.

FIG. 41 is a view illustrating an image display device according to a seventh embodiment of the present technology.

FIG. 42 is a view illustrating an image display device according to an eighth embodiment of the present technology.

FIG. 43 is a view illustrating an image display device according to a ninth embodiment of the present technology.

### DESCRIPTION OF EMBODIMENTS

Hereinafter, preferred embodiments of the present technology will be described in detail with reference to the accompanying drawings. Note that constituent elements having substantially the same functional configuration in the present specification and the drawings will be denoted by the same reference sign, and the redundant description thereof will be omitted. The embodiments described below illustrate representative embodiments of the present technology, and the scope of the present technology is not narrowly interpreted by these embodiments. In the description, even in a case where it is described that each of a light source device and an image display device according to the present technology exhibits a plurality of effects, each of the light source device and the image display device according to the present technology is only required to exhibit at least one effect. The effects described in the present specification are merely examples and are not limited, and other effects may be present.

Furthermore, a description will be given in the following order.
0. Introduction
1. Basic Concept as Base of Present Technology
2. Configuration Example 1 of Light Source Device According to Present Technology
3. Configuration Examples 1 and 2 of Image Display Device According to Present Technology
4. Feature 1 of Present Technology
5. Feature 2 of Present Technology
6. Feature 3 of Present Technology
7. Adjustment Sensitivity
8. Configuration Examples 3 to 5 of Image Display Device According to Present Technology
9. Volumes of Light Source Device According to Present Technology and Light Source Device of Related Art
10. Image Display Devices According to First to Ninth Embodiments of Present Technology
11. Modified Examples of Present Technology

### 0. Introduction

In related art, for example, in an image display device using a laser as a light source, such as a projector, an approach to increase efficiency of an optical system is taken for the purpose of compensating for an insufficient amount of light of the light source. Specifically, an NA of a lens forming an image is increased in order to increase image forming efficiency.

On the other hand, for example, in an image display device for direct retinal projection, it is necessary to reduce the amount of light from a light source using an additional component such as an optical filter (for example, a neutral density (ND) filter) in order to ensure safety for a retina. For this reason, there is a problem that cost increases due to the addition of the component and a space for installing the additional component is required.

Therefore, as a result of intensive studies, the inventor has developed a light source device according to the present technology as a light source device capable of coping with an excessive amount of light of a light source without using an additional component such as an optical filter.

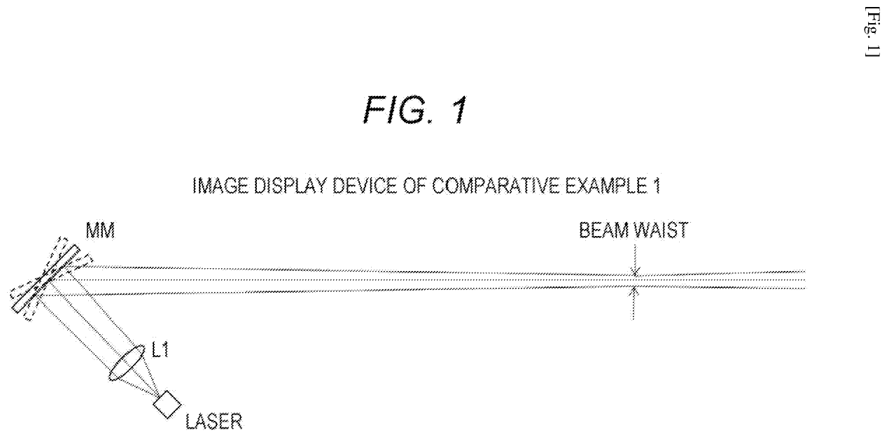

Meanwhile, in a laser scanning projector, laser light fluxes corresponding to one pixel are emitted in a substantially parallel state. Laser beams gradually converge to a beam waist, a beam diameter becomes the smallest at the beam waist, and gradually diverges after the beam waist. In order to enhance resolution of an optical system in an image display device of Comparative Example 1 illustrated in FIG. 1, it is necessary to increase an NA of a lens L1 to narrow down beams. This means that a large light flux diameter proportional to a distance to a projection plane is required on a lens closest to the projection plane. In Comparative Example 1, when an attempt is made to increase the NA of the lens L1, a size of a scanning mirror MM becomes a limitation so that the light flux diameter is restricted. It is necessary to increase the size of the scanning mirror MM in order to be free from the restriction. In such a case, however, response characteristics are deteriorated, a device size increases, and the cost increases.

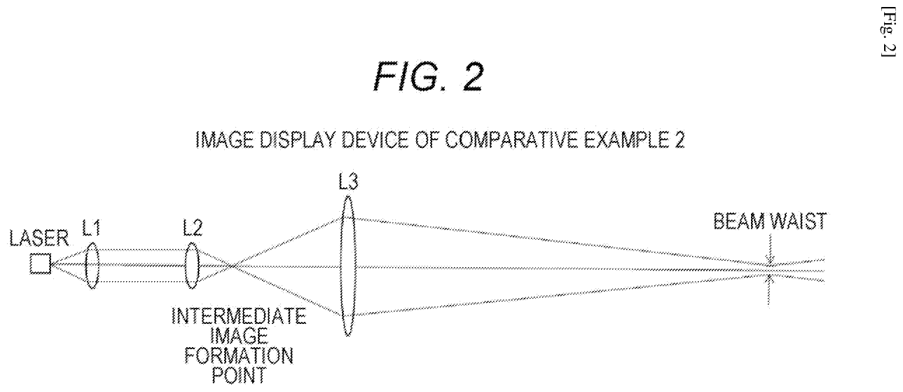

In an image display device of Comparative Example 2 illustrated in FIG. 2, an intermediate image formation point is provided in an optical system in order to enhance resolution with an aim of resolution improvement, but it is necessary to add lenses L2 and L3 that generate the intermediate image formation point in addition to the lens L1, which leads to an increase in cost.

Therefore, the inventor has further conducted studies and developed an image display device including the light source device according to the present technology as an image display device capable of enhancing resolution of an optical system while suppressing deterioration of response characteristics, an increase in a device size, and an increase in cost.

### 1. Basic Concept as Base of Present Technology

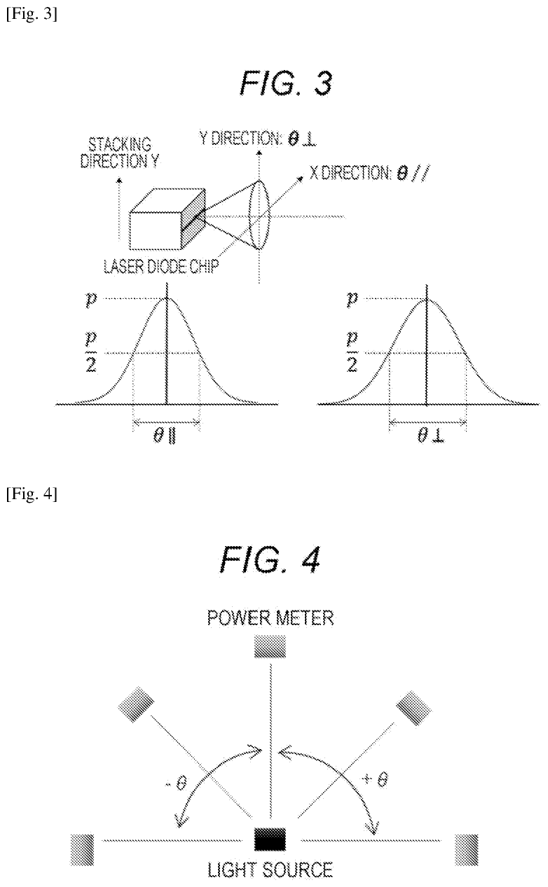

As illustrated in FIG. 3, a laser light source (for example, a laser diode (LD)) radiates laser light at a predetermined radiation angle (divergence angle). The radiation angle of the LD includes a radiation angle θ⊥ in a Y direction which is a stacking direction of laser diode chips (LD chips), and a radiation angle θ// in an X direction which is a direction perpendicular to the stacking direction. Each of the radiation angles can be defined as an angle that is a half value obtained by normalization of a peak intensity of a Gaussian distribution which is an intensity distribution of laser beams. In the present specification, a sum of θ⊥ and θ// is referred to as a “radiation angle sum”. As may be appreciated from FIG. 3, the radiation angle sum is a sum of a first radiation angle measured with respect to a first direction (e.g., y direction) and a second radiation angle measured with respect to a second direction (e.g., x direction) orthogonal to the first direction. As an example, the laser diode chip has a double hetero structure in which a first cladding layer, an active layer, and a second cladding layer are stacked in this order in the Y direction. Note that the laser diode is also called an “edge-emitting laser”.

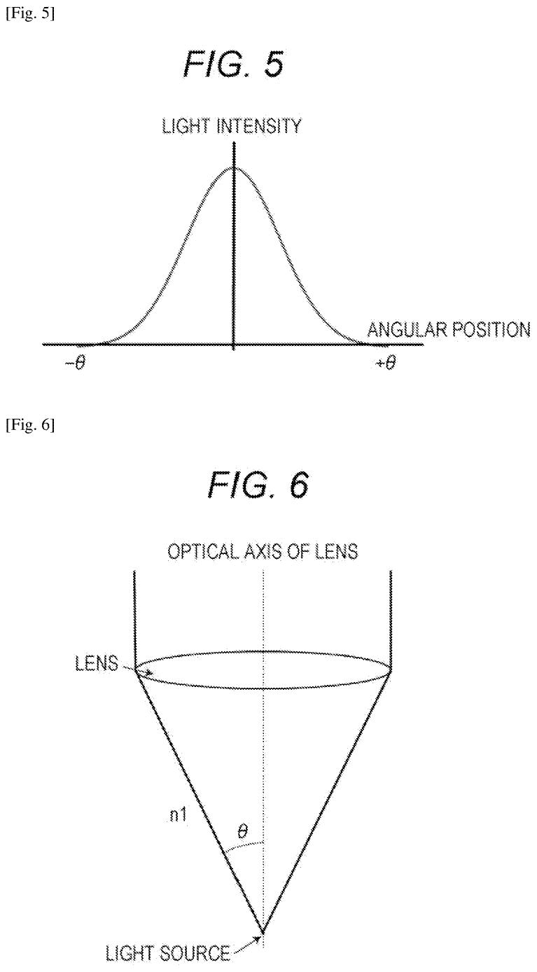

The radiation angle can be measured by a measuring device including a power meter illustrated in FIG. 4. This measurement is performed by installing the power meter at a position separated from a position where the light source is installed by a predetermined distance. The power meter is rotated around the light source to measure a light intensity. A measured value of the power meter changes as illustrated in FIG. 5 depending on an angular position of the power meter. The radiation angle can be calculated by a method illustrated in FIG. 3 on the basis of the measured value.

As illustrated in FIG. 6, a numerical aperture (NA) of a lens is expressed by the following Formula (1) using a maximum angle θ of a light ray incident on the lens with respect to an optical axis and a refractive index n1 of a medium between the light source and the lens.

$$NA = n 1 \times sin θ \qquad ( 1 )$$

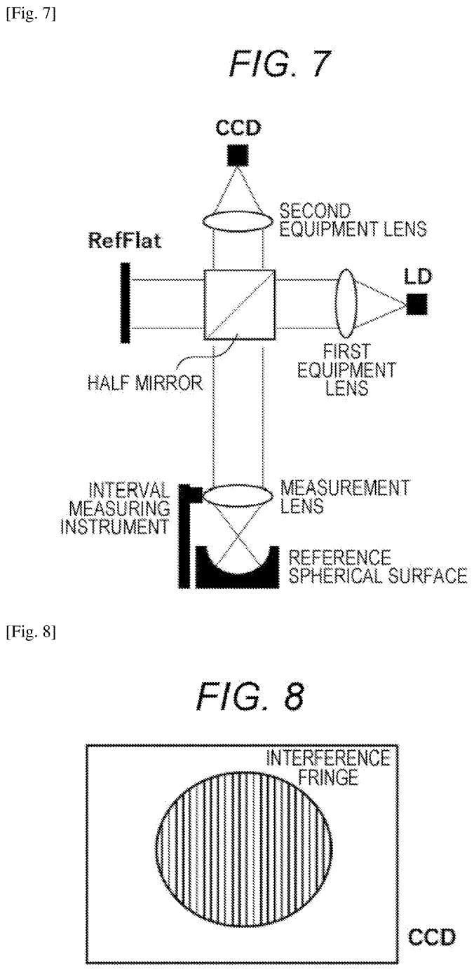

Normally, the medium between the light source and the lens in the light source device is air, and n1=1.0. The NA can be measured using an interferometer illustrated in FIG. 7. The interferometer in FIG. 7 is a commonly used interferometer. In this interferometer, light from the LD is transmitted through a first equipment lens and is incident on a half mirror, and is branched into reflected light and transmitted light by the half mirror. The reflected light branched by the half mirror passes through a measurement lens (lens to be measured), is reflected by a reference spherical surface (concave mirror), passes through the measurement lens again, and is incident on a CCD via the half mirror and a second equipment lens. The transmitted light branched by the half mirror is reflected by RefFlat (plane mirror), reflected by the half mirror, and incident on the CCD via the second equipment lens. At this time, the CCD captures an image of an interference fringe generated as the transmitted light and the reflected light branched by the half mirror merge and interfere as illustrated in FIG. 8. Therefore, a captured interference range is measured to calculate an effective diameter R of the measurement lens. Furthermore, it is possible to measure a distance between the reference spherical surface and the measurement lens by an interval measuring instrument and calculate a focal length F of the measurement lens from a measured value thereof and a thickness of the measurement lens.

The NA of the measurement lens can be obtained from the following Formulas (2) to (4) using the effective diameter R and the focal length F.

$$\begin{matrix}[ Math . 1 ] & \\ α = \frac{R}{2} & ( 2 )\end{matrix}$$

$$\begin{matrix}[ Math . 2 ] & \\ T = \frac{α}{F} & ( 3 )\end{matrix}$$

$$\begin{matrix}[ Math . 3 ] & \\ NA = sin ( {tan}^{- 1} T ) & ( 4 )\end{matrix}$$

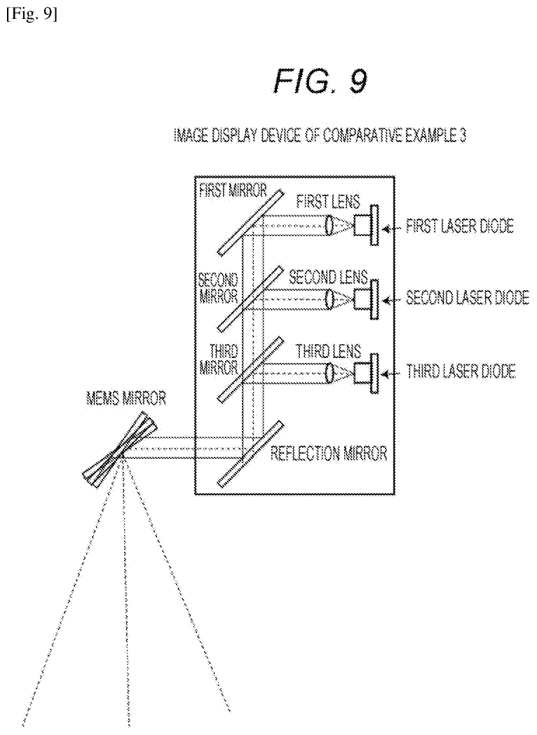

An image display device of Comparative Example 3 illustrated in FIG. 9 is a projector, and includes: a first laser diode that emits red light (laser light having a red component); a second laser diode that emits green light (laser light having a green component); a third laser diode that emits blue light (laser light having a blue component); first to third lenses into which beams of the laser light from the first to third laser diodes are incident, respectively; and a combining unit including first to third mirrors and combining the beams of the laser light respectively passing through the first to third lenses. Each of the first to third lenses is a collimator lens that converts the laser light from each of the first to third laser diodes from divergent light to substantially parallel light. Laser light (combined light) combined by the combining unit is incident on a MEMS mirror via a reflection mirror to be deflected and scanned, and an image is formed on a display surface (for example, a screen surface, a wall surface, or the like).

Regarding the light emitted from each of the laser diodes, only light transmitted through the corresponding lens can form an image, and efficiency v can be obtained from the following Formulas (5) to (7).

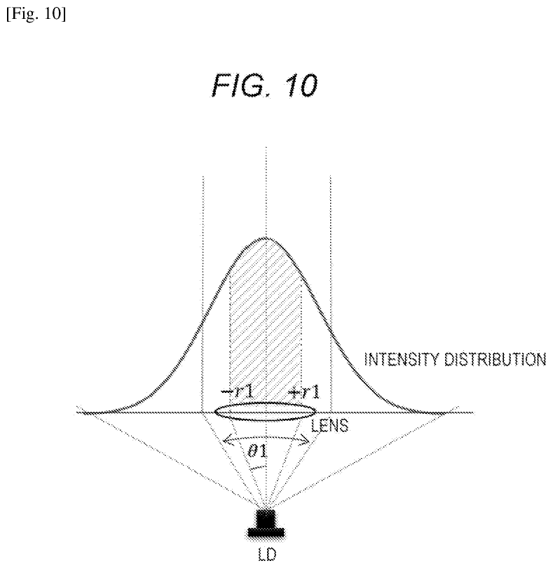

Image forming efficiency v₁ in a case where there is a lens is expressed by the following Formula (5) (see FIG. 10).

$$\begin{matrix}[ Math . 4 ] & \\ {v}_{1} = {\int }_{- r}^{+ r} {e}^{- {a}^{x 2}} dx & ( 5 )\end{matrix}$$

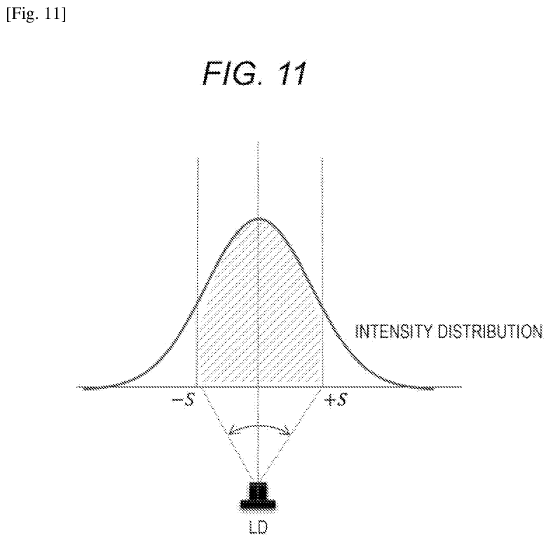

The image forming efficiency v₀ in a case where there is no lens is expressed by the following Formula (6) (see FIG. 11).

$$\begin{matrix}[ Math . 5 ] & \\ {v}_{0} = {\int }_{- s}^{+ s} {e}^{- {a}^{x 2}} dx & ( 6 )\end{matrix}$$

The efficiency v of light transmitted through the lens can be obtained from Formulas (5) and (6) described above and the following Formula (7).

$$\begin{matrix}[ Math . 6 ] & \\ Efficiency v = \frac{{v}_{1}}{{ν}_{0}} & ( 7 )\end{matrix}$$

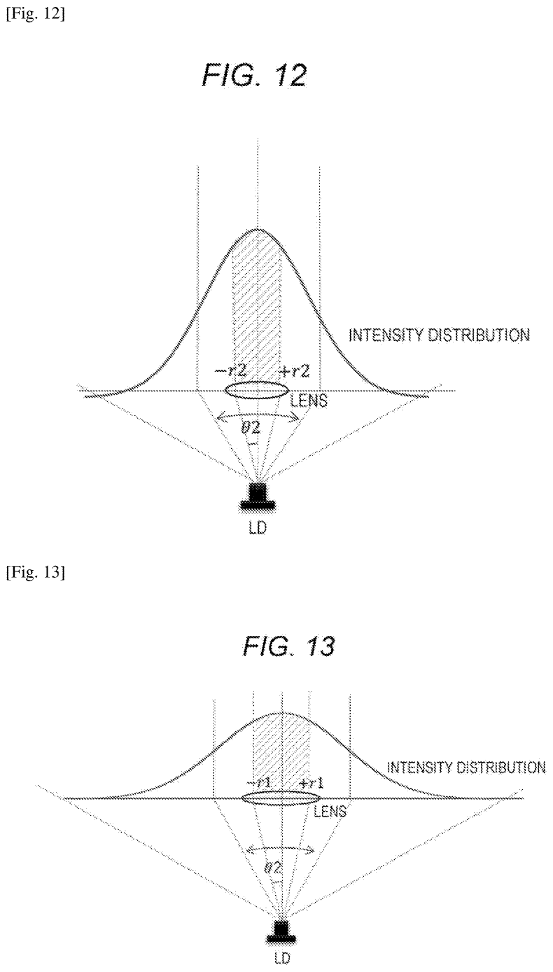

Image forming efficiency v₂ of a lens having a small NA is expressed by the following Formula (8) (see FIG. 12).

$$\begin{matrix}[ Math . 7 ] & \\ {v}_{2} = {\int }_{- r 2}^{+ r 2} {e}^{- {a}^{x 2}} dx & ( 8 )\end{matrix}$$

In a case where the NA of the lens is small, a light amount of light emitted from the light source to be taken in by the lens decreases, so that the following Formula (9) is established.

$$\begin{matrix}[ Math . 8 ] & \\ {v}_{1} < {v}_{2} & ( 9 )\end{matrix}$$

Furthermore, a focal length of the lens can also be increased as a method for reducing the NA (see FIG. 13). Image forming efficiency v₃ of the lens in this case is expressed by the following Formula (10), and Formula (11) is established between v₃ and v₂.

$$\begin{matrix}[ Math . 9 ] & \\ {v}_{3} = {\int }_{- r 1}^{+ r 1} {e}^{- {a}^{x 2}} dx & ( 10 )\end{matrix}$$

$$\begin{matrix}[ Math . 10 ] & \\ {v}_{2} = {v}_{3} & ( 11 )\end{matrix}$$

### 2. Configuration Example 1 of Light Source Device According to Present Technology

Hereinafter, Configuration Example 1 of the light source device according to the present technology will be described in comparison with a comparative example.

### (Configuration Example 1 of Light Source Device)

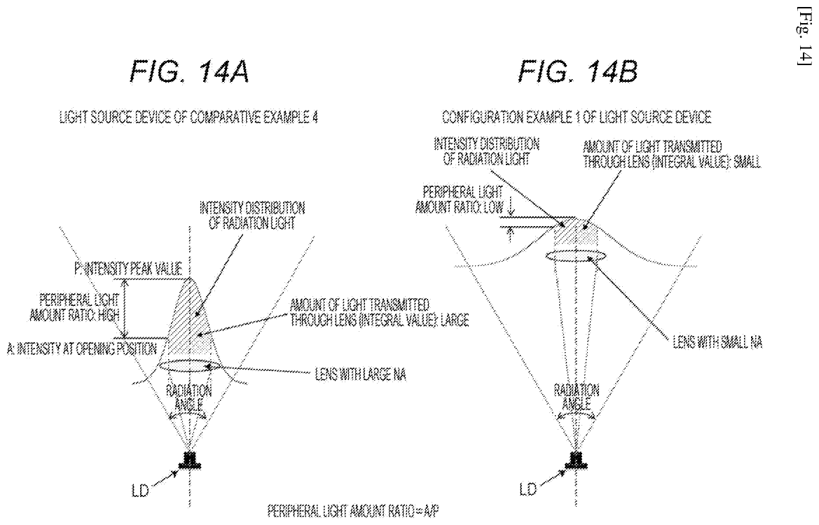

FIG. 14A is a view illustrating a light source device according to Comparative Example 4. FIG. 14B is a view illustrating Configuration Example 1 of the light source device according to the present technology.

In the light source device according to Comparative Example 4, a lens having a large NA (for example, NA>0.16) is disposed on an optical path of light radiated from an LD as illustrated in FIG. 14A. Therefore, an intensity distribution of radiation light radiated from the LD and passing through the lens shows a steep Gaussian distribution. In this case, a peripheral light amount ratio A/P (A: intensity at lens opening position, P: peak intensity), which is a ratio of the intensity A at the lens opening position to the peak intensity P, increases, and an integrated light amount, which is an integral value of a light amount of light transmitted through the lens, also increases. That is, the light source device according to Comparative Example 4 is suitable for an insufficient amount of light of a light source (contributes to an increase in efficiency), and has a very simple configuration including only the LD and the lens. The lens is, for example, a collimator lens (also referred to as a collimating lens).

In Configuration Example 1 of the light source device according to the present technology, a lens (for example, a spherical lens or an aspherical lens) having a small NA (for example, NA≤0.16) is disposed on an optical path of light radiated from an LD as illustrated in FIG. 14B. Therefore, an intensity distribution of radiation light radiated from the LD and passing through the lens shows a gentle Gaussian distribution, a peripheral light amount ratio A/P (A: intensity at lens opening position, P: peak intensity), which is a ratio of the intensity A at the lens opening position to the peak intensity P, decreases, and an integrated light amount, which is an integral value of a light amount of light transmitted through the lens, also decreases. That is, Configuration Example 1 of the light source device is suitable for an excessive light amount of a light source (contributes to a decrease in efficiency), and has a very simple configuration including only the LD and the lens. The lens is, for example, a collimator lens (also referred to as a collimating lens).

Note that, instead of the LD, another semiconductor laser such as a vertical cavity surface emitting laser (VCSEL) may be used as the light source in Configuration Example 1 of the light source device.

### 3. Configuration Examples 1 and 2 of Image Display Device According to Present Technology

Hereinafter, Configuration Examples 1 and 2 of the image display device according to the present technology will be described in comparison with comparative examples.

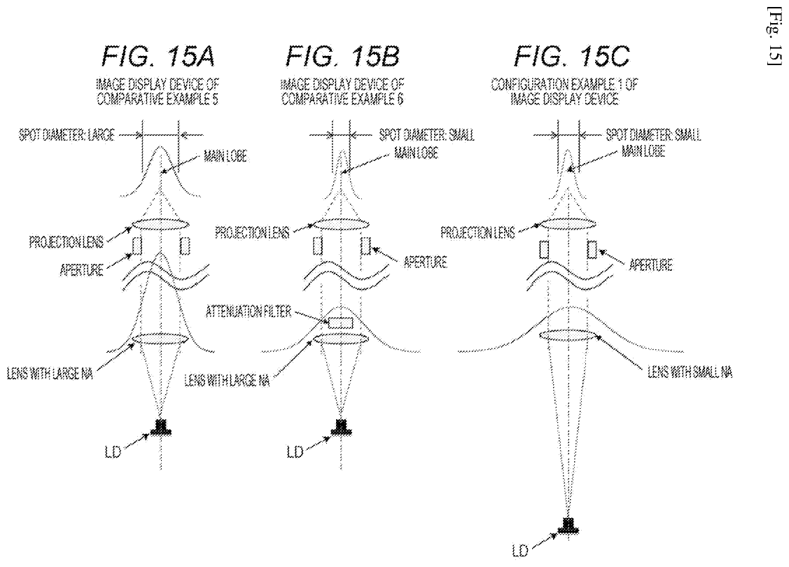

FIG. 15A is a view illustrating an image display device according to Comparative Example 5. FIG. 15B is a view illustrating an image display device according to Comparative Example 6. FIG. 15C is a view illustrating Configuration Example 1 of the image display device according to the present technology.

Meanwhile, in general, light radiated from a light source in an image display device is converted into substantially parallel light or convergent light by a lens, converted into light for forming an image by an image forming unit, and then condensed (imaged) to a predetermined spot size by a projection lens. An image forming unit may also be referred to as an image forming system. A spot diameter of the light condensed by the projection lens is an element that determines resolution in the image display device. Therefore, it is required to reduce the spot diameter.

In the image display device according to Comparative Example 5, a lens having a large NA (for example, NA>0.16) is disposed on an optical path of light radiated from an LD, and an aperture (opening member) and a projection lens are disposed on an optical path of light passing through the lens in this order from the lens side as illustrated in FIG. 15A. An image forming unit (not illustrated) that forms an image with the light is disposed on an optical path of the light between the lens and the projection lens. That is, the image display device according to Comparative Example 5 has a configuration in which the image forming unit, the aperture, and the projection lens are added to the light source device according to Comparative Example 4 (see FIG. 14A). In the image display device according to Comparative Example 5, an intensity distribution of the radiation light radiated from the LD and passing through the lens shows a steep Gaussian distribution, an integrated light amount, which is an integral value of a light amount of the radiation light, increases, and a spot diameter of the main lobe of the light passing through the image forming unit, the aperture, and the projection lens also increases. Thus, it is possible to achieve an increase in efficiency in the image display device according to Comparative Example 5, but there is room for improvement regarding resolution enhancement.

In the image display device according to Comparative Example 6, a lens having a large NA (for example, NA>0.16) is disposed on an optical path of light radiated from an LD, an attenuation filter (ND filter) is disposed on an optical path of light passing through the lens, and an aperture (opening member) and a projection lens are disposed in this order from the attenuation filter side on an optical path of light passing through the attenuation filter as illustrated in FIG. 15B. An image forming unit (not illustrated) that forms an image with the light is disposed on an optical path of the light between the attenuation filter and the projection lens. That is, the image display device according to Comparative Example 6 has a configuration in which the attenuation filter, the image forming unit, the aperture, and the projection lens are added to the light source device according to Comparative Example 4 (see FIG. 14A). In the image display device according to Comparative Example 6, an intensity distribution of the radiation light radiated from the LD and passing through the lens and the attenuation filter in this order shows a gentle Gaussian distribution, an integrated light amount, which is an integrated value of a light amount of the radiation light, decreases, and a spot diameter of the main lobe of the light passing through the image forming unit, the aperture, and the projection lens also decreases. That is, in the image display device according to Comparative Example 6, the spot diameter can be decreased by reducing a central light amount of the light intensity distribution by the attenuation filter and increasing a peripheral light amount. Thus, it is possible to achieve a decrease in efficiency and resolution enhancement in the image display device according to Comparative Example 6, but the attenuation filter as an additional component is required, which leads to an increase in cost.

In Configuration Example 1 of the image display device according to the present technology, a lens (for example, a spherical lens or an aspherical lens) having a small NA (for example, NA≤0.16) is disposed on an optical path of light radiated from an LD (light source), and an aperture (opening member) and a projection optical system (also called a projection system), which may include a projection lens, are disposed in this order from a lens side on an optical path of light passing through the lens as illustrated in FIG. 15C. An image forming unit (not illustrated) that forms an image with the light is disposed on an optical path of the light between the lens and the projection lens. That is, Configuration Example 1 of the image display device has a configuration in which the image forming unit, the aperture, and the projection lens are added to Configuration Example 1 of the light source device (see FIG. 14B). In Configuration Example 1 of the image display device, an intensity distribution of the radiation light radiated from the LD and passing through the lens shows a gentle Gaussian distribution, an integrated light amount, which is an integrated value of a light amount of the radiation light, decreases, and a spot diameter of the main lobe of the light passing through the image forming unit, the aperture, and the projection lens also decreases. Thus, Configuration Example 1 of the image display device can achieve a decrease in efficiency and resolution enhancement without using an optical component such as an attenuation filter. In this manner, when the lens having a small NA is used, it is possible to reduce a projection light amount and to reduce the spot diameter of light used for image display (resolution enhancement).

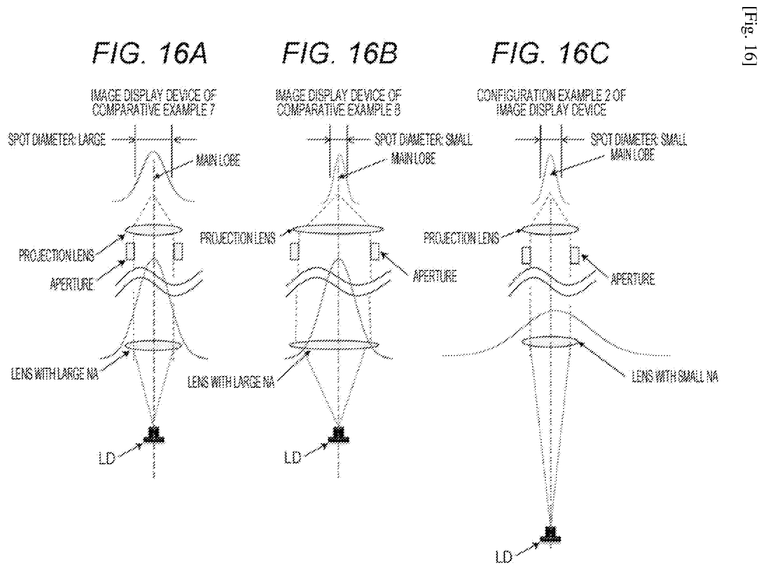

FIG. 16A is a view illustrating an image display device according to Comparative Example 7. FIG. 16B is a view illustrating an image display device according to Comparative Example 8. FIG. 16C is a view illustrating Configuration Example 2 of the image display device according to the present technology.

In the image display device according to Comparative Example 7, a lens having a large NA (for example, NA>0.16) is disposed on an optical path of light radiated from an LD, and an aperture (opening member) and a projection lens are disposed on an optical path of light passing through the lens in this order from the lens side as illustrated in FIG. 16A. An image forming unit (not illustrated) that forms an image with the light is disposed on an optical path of the light between the lens and the projection lens. That is, the image display device according to Comparative Example 5 has a configuration in which the image forming unit, the aperture, and the projection lens are added to the light source device according to Comparative Example 4 (see FIG. 14A). In the image display device according to Comparative Example 7, an intensity distribution of the radiation light radiated from the LD and passing through the lens shows a steep Gaussian distribution, an integrated light amount, which is an integral value of a light amount of the radiation light, increases, and a spot diameter of the main lobe of the light passing through the image forming unit, the aperture, and the projection lens also increases. Thus, it is possible to achieve an increase in efficiency in the image display device according to Comparative Example 5, but there is room for improvement regarding resolution enhancement.

In the image display device according to Comparative Example 8, a large-diameter lens having a large NA (for example, NA>0.16) is disposed on an optical path of light radiated from an LD, and a large-diameter aperture (opening member) and a large-diameter projection lens having high power (refractive power) are disposed on an optical path of light passing through the lens as illustrated in FIG. 16B. An image forming unit (not illustrated) that forms an image with the light is disposed on an optical path of the light between the lens and the projection lens. That is, the image display device according to Comparative Example 8 has a configuration in which the image forming unit, the aperture, and the projection lens having a large diameter and high power are added to the light source device according to Comparative Example 4 (see FIG. 14A), and the diameter of the lens is increased. In the image display device according to Comparative Example 8, an intensity distribution of the radiation light radiated from the LD and passing through the large-diameter lens shows a steep Gaussian distribution, a peripheral light amount ratio becomes high, and an integrated light amount, which is an integrated value of a light amount of the radiation light, becomes very large, but a spot diameter of the main lobe of the light passing through the image forming unit, the aperture, and the projection lens having high power decreases. Thus, it is possible to achieve an increase in efficiency and resolution enhancement in the image display device according to Comparative Example 8, but sizes of the lens, the aperture, and the projection lens increase, which leads to an increase in cost.

In Configuration Example 2 of the image display device according to the present technology, a lens (optical system) having a small NA (for example, NA≤0.16) and a long focal length is disposed on an optical path of light radiated from an LD (light source), and an aperture (opening member) and a projection optical system, which may include a projection lens, are disposed on an optical path of light passing through the lens as illustrated in FIG. 16C. An image forming unit (not illustrated) that forms an image with the light is disposed on an optical path of the light between the lens and the projection lens. That is, Configuration Example 2 of the image display device has a configuration in which the image forming unit, the aperture, and the projection lens are added to Configuration Example 1 of the light source device (see FIG. 14B), and the focal length of the lens is increased. In Configuration Example 2 of the image display device, an intensity distribution of the radiation light radiated from the LD and passing through the lens shows a gentle Gaussian distribution, an integrated light amount, which is an integrated value of a light amount of the radiation light, decreases, and a spot diameter of the main lobe of the light passing through the image forming unit, the aperture, and the projection lens also decreases. Thus, Configuration Example 2 of the image display device can achieve a decrease in efficiency and resolution enhancement without using an optical component such as an attenuation filter. In this manner, when the lens having a small NA and a long focal length is used, it is possible to reduce a projection light amount and to reduce the spot diameter of light passing through the projection lens (enhance the resolution).

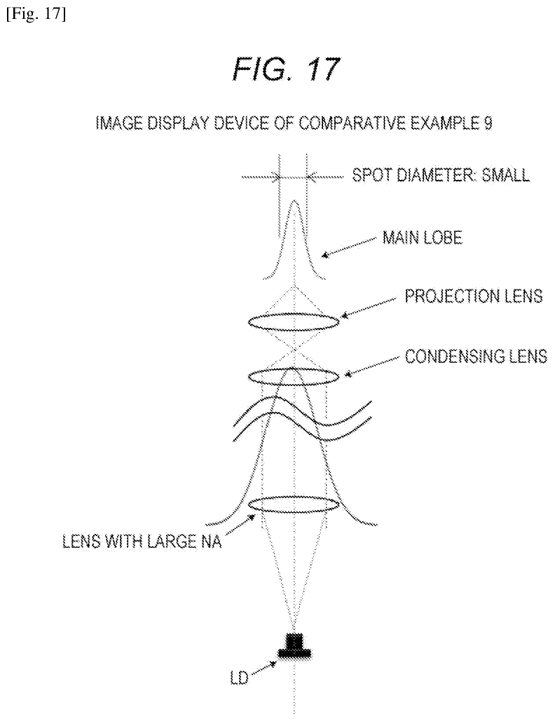

FIG. 17 is a view illustrating an image display device according to Comparative Example 9. In the image display device according to Comparative Example 9, a lens having a large NA (for example, NA>0.16) is disposed on an optical path of light radiated from an LD, and a condensing lens and a projection lens are disposed on an optical path of light passing through the lens in this order from the lens side as illustrated in FIG. 17. An image forming unit (not illustrated) that forms an image with the light is disposed on an optical path of the light between the lens and the projection lens. That is, the image display device according to Comparative Example 9 has a configuration in which the image forming unit, the condensing lens, and the projection lens are added to the light source device according to Comparative Example 4 (see FIG. 14A). In the image display device according to Comparative Example 9, an intensity distribution of the radiation light radiated from the LD and passing through the lens shows a steep Gaussian distribution, a peripheral light amount ratio increases, and an integrated light amount, which is an integral value of a light amount of the radiation light, increases, but a spot diameter of the main lobe of the light passing through the projection lens decreases since an intermediate image formation point is formed on an optical path between the condensing lens and the projection lens. Thus, it is possible to achieve an increase in efficiency and resolution enhancement in the image display device according to Comparative Example 9, but the condensing lens as an additional component is required, which leads to an increase in cost.

According to Configuration Examples 1 and 2 of the image display device of the present technology described above, the spread of the intensity distribution of light after transmission through the projection lens is reduced by decreasing the NA of the lens, and as a result, the spot diameter of the main lobe can be decreased. That is, it is possible to decrease the spot diameter of light used for image display (enhance the resolution) without increasing the size of the lens or the like or adding an optical component according to Configuration Examples 1 and 2 of the image display device.

Note that, instead of the LD, in Configuration Examples 1 and 2 of the image display device, another laser such as a VCSEL (surface emitting laser) may be used as the light source.

### (Principle of Resolution Enhancement)

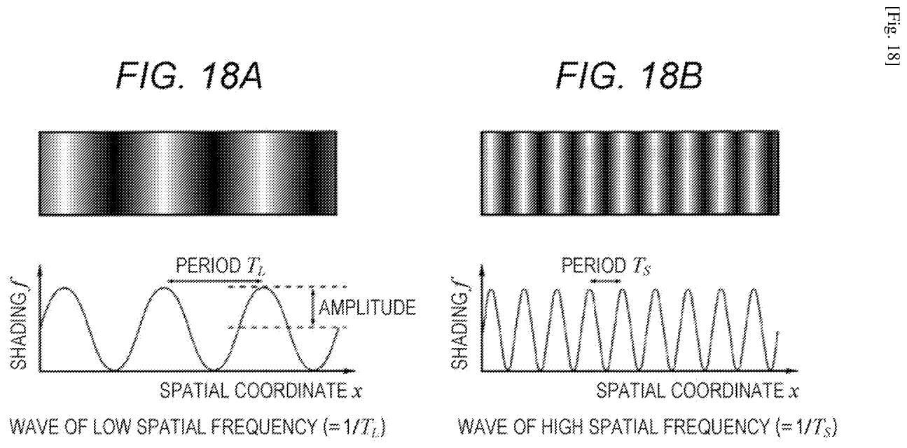

FIG. 18A is a view illustrating shading of a wave having a low spatial frequency (1/T_{L}). FIG. 18B is a view illustrating shading of a wave having a high spatial frequency (1/Tₛ). When a spot diameter of radiation light is set to be smaller, a wave having a higher spatial frequency can be generated, and resolution can be improved.

### 4. Feature 1 of Present Technology

### (Setting of Numerical Aperture)

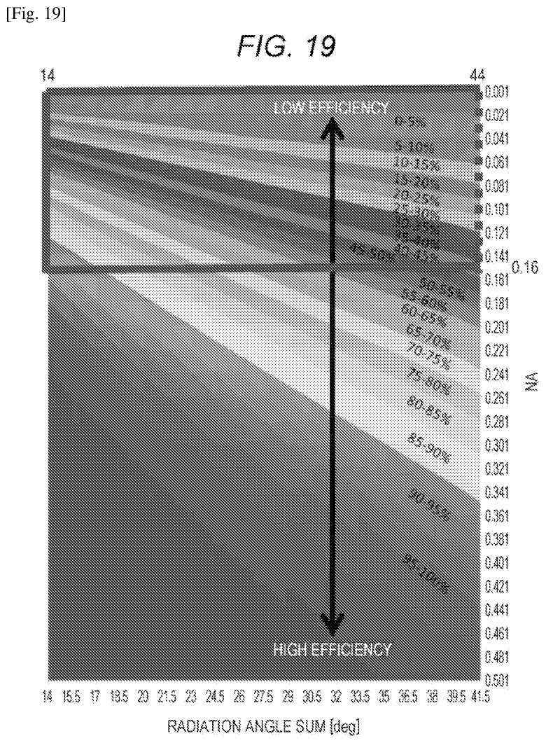

FIG. 19 is a view (Part 1) illustrating a relationship among a radiation angle sum, a numerical aperture, and efficiency. In FIG. 19, the horizontal axis represents the radiation angle sum [deg], the vertical axis represents the numerical aperture (NA), and the efficiency v is indicated in %. As illustrated in FIG. 19, the efficiency v (v₁/v₀) increases as the NA increases and decreases as the NA decreases under a condition that the radiation angle sum is constant. Furthermore, the efficiency v decreases as the radiation angle sum increases and increases as the radiation angle sum decreases under a condition that the NA is constant. Collimator lenses and condensing lenses of related art are required to have high efficiency regardless of applications, and thus, those having an NA of 0.17 or more are used. Specifically, an NA of a collimator lens of a light source device for communication in related art is about 0.17 to 0.30. An NA of a collimator lens of a light source device for optical pickup (OPU) in related art is about 0.22 to 0.30. An NA of a collimator lens for a projector in related art is about 0.24 to 0.26. An NA of a condensing lens for a projector in related art is about 0.40 to 0.60.

Therefore, in the light source device (for example, Configuration Example 1 of the light source device) and the image display device (for example, Configuration Examples 1 and 2 of the image display device) according to the present technology, the numerical aperture (NA) of a lens is set to 0.16 or less. Therefore, for example, in a case where the light source device and the image display device are used for direct retinal projection, the amount of light can be reduced without using an optical filter such as an ND filter, and safety for a retina can be secured. Furthermore, for example, in a case where the light source device and the image display device are used for projection in a dark environment, it is possible to reduce the amount of light without using an optical filter such as an ND filter, and it is also possible to cope with a need to cut an unnecessary amount of light in advance.

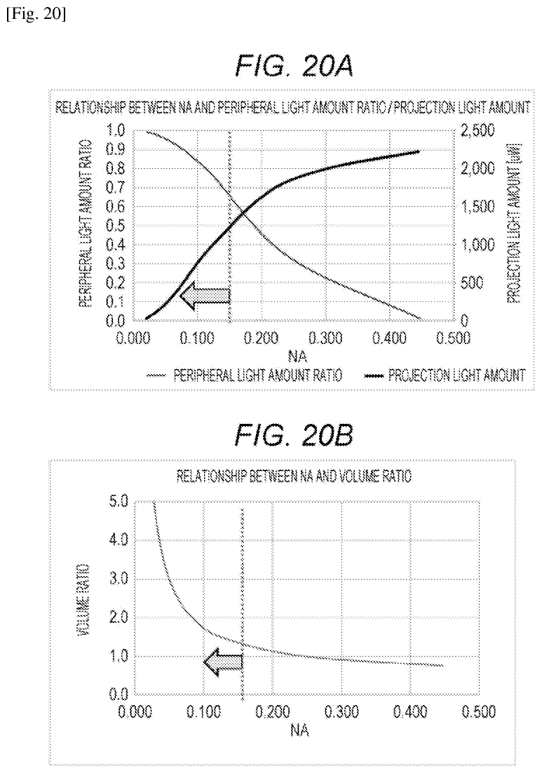

FIG. 20A is a view illustrating a relationship among a numerical aperture (NA), a peripheral light amount ratio, and a projection light amount. In particular, in an application for direct retinal projection, it is desirable to reduce the projection light amount as much as possible and increase the peripheral light amount ratio as much as possible, and thus, it is effective that the NA is 0.16 or less (see FIG. 20A).

FIG. 20B is a view illustrating a relationship between the numerical aperture (NA) and a volume ratio. FIG. 20B illustrates a relationship between the NA and a device volume (the volume ratio) assuming that a device volume with an NA of 0.24 is 1.0. As the NA of a lens becomes smaller, a focal length F is longer, and the device tends to be larger. Therefore, the NA is preferably, for example, 0.03 or more from the viewpoint of reducing the volume ratio. Therefore, the volume ratio can be suppressed to 4.0 or less.

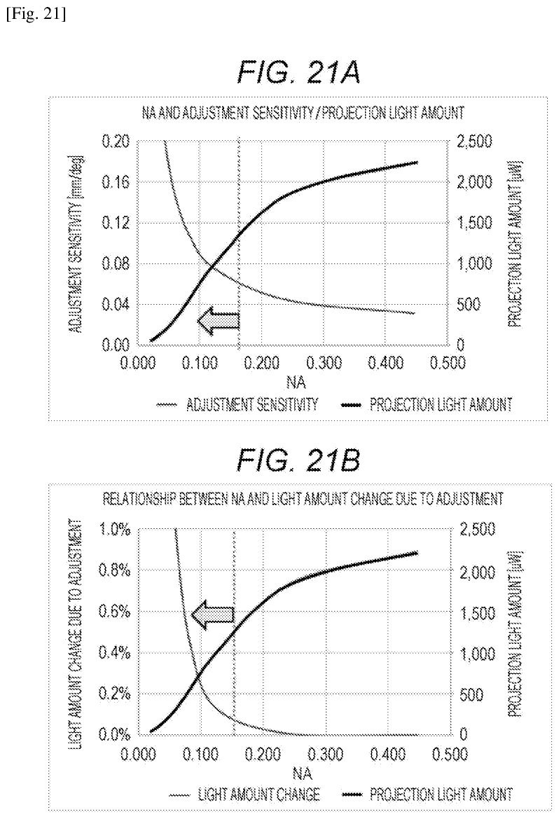

FIG. 21A is a view illustrating a relationship among a numerical aperture (NA), adjustment sensitivity, and a projection light amount. FIG. 21B is a view illustrating a relationship among the numerical aperture and a light amount change due to adjustment (a positional deviation and an angular deviation between a light source and a lens). In particular, in the application for direct retinal projection, it is desirable that the NA be small from the viewpoint of reducing the projection light amount, but the adjustment sensitivity increases as the NA decreases (see FIG. 21A). When the adjustment sensitivity increases, the light amount change due to an error (an amount of the positional deviation and an amount of the angular deviation between the light source and the lens) increases (see FIG. 21B), and a gap from an aimed light amount (target light amount) increases. Thus, it is preferable to set the NA to a value at which the light amount change due to adjustment is small. Specifically, the NA is preferably set to, for example, 0.05 or more. Therefore, the light amount change due to adjustment can be suppressed to 1.0% or less. Details of the adjustment sensitivity will be described later.

### (Setting of Radiation Angle Sum)

In the light source device and the image display device according to the present technology, a radiation angle sum of the light source (for example, an LD) is set to 14° or more. In a case where the NA is 0.16 or less and the radiation angle sum is 14° or more, the efficiency v can be suppressed to 95% or less (see FIG. 19).

It is more preferable as the radiation angle sum is larger from the viewpoint of lowering the efficiency v. For example, in a case where the NA is 0.16 or less and the radiation angle sum is 18° or more, the efficiency v can be suppressed to 90% or less (see FIG. 19). For example, in a case where the NA is 0.16 or less and the radiation angle sum is 22° or more, the efficiency v can be suppressed to 80% or less (see FIG. 19). For example, in a case where the NA is 0.16 or less and the radiation angle sum is 26° or more, the efficiency v can be suppressed to 70% or less (see FIG. 19). For example, in a case where the NA is 0.16 or less and the radiation angle sum is 31° or more, the efficiency v can be suppressed to 60% or less (see FIG. 19). For example, in a case where the NA is 0.16 or less and the radiation angle sum is 37° or more, the efficiency v can be suppressed to 50% or less (see FIG. 19).

Although FIG. 19 illustrates a range in which the radiation angle sum is 44° or less, the radiation angle sum may be more than 44°. In such a case, the efficiency v can be further reduced.

### 5. Feature 2 of Present Technology

### (Setting of Numerical Aperture)

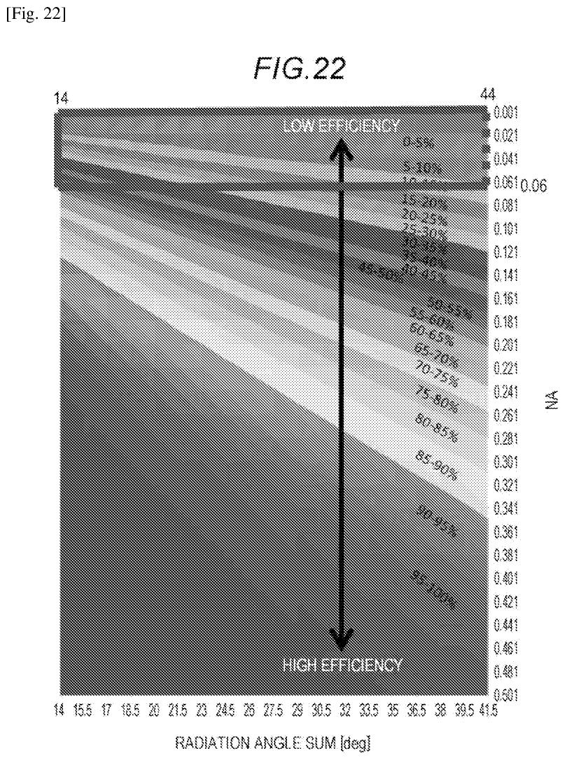

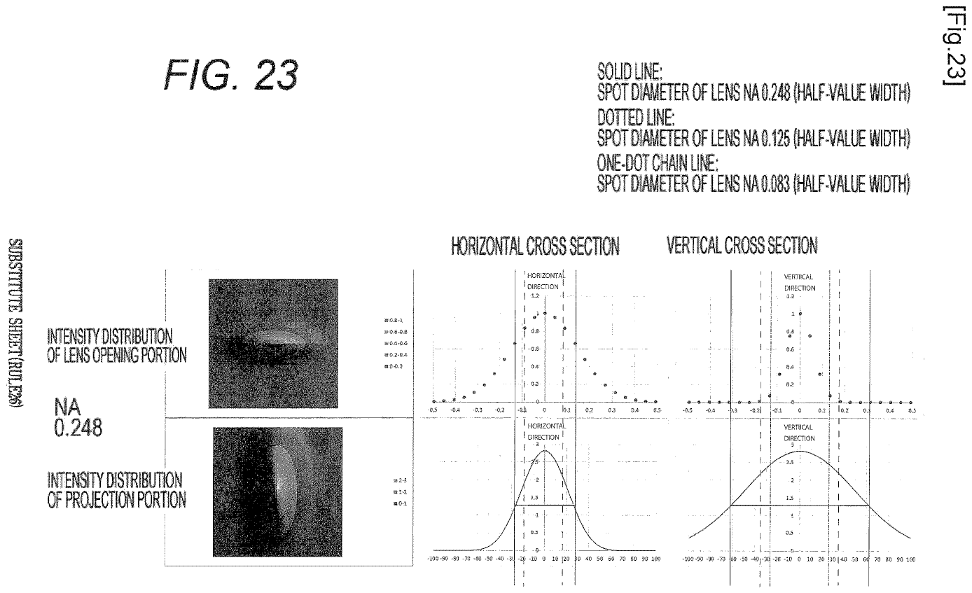

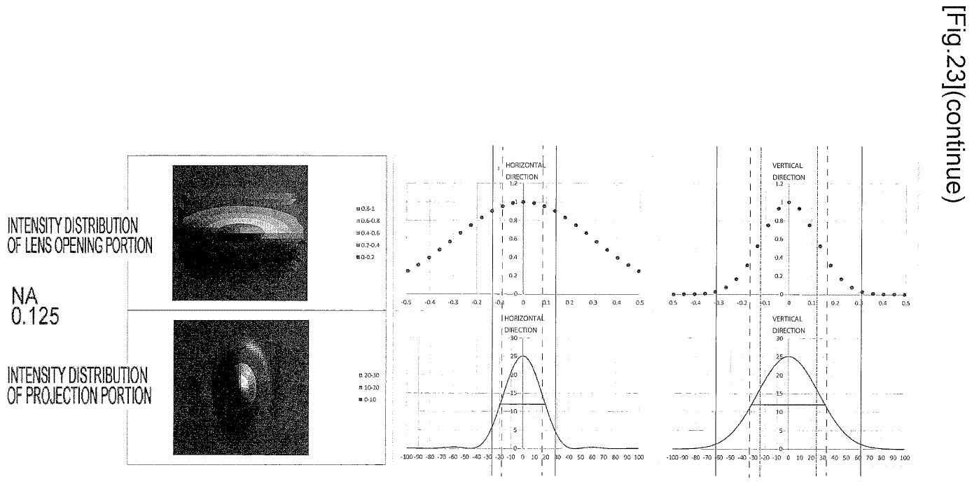

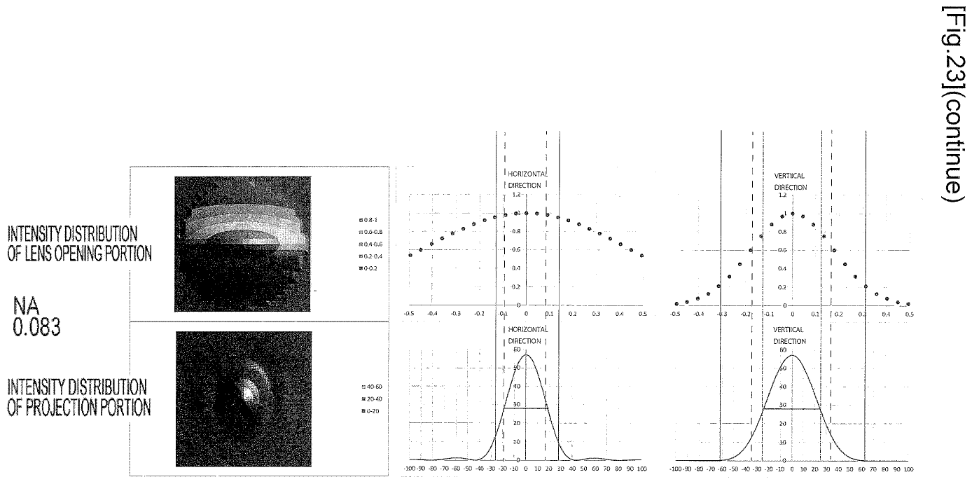

FIG. 22 is a view (Part 2) illustrating a relationship among a radiation angle sum, a numerical aperture, and efficiency. In FIG. 22, the horizontal axis represents the radiation angle sum [deg], the vertical axis represents the numerical aperture (NA), and the efficiency v is indicated in %. FIG. 22 is a view similar to FIG. 19 except that a setting range of the numerical aperture is different.

In the light source device (for example, Configuration Example 1 of the light source device) and the image display device (for example, Configuration Examples 1 and 2 of the image display device) according to the present technology, the numerical aperture (NA) of a lens is preferably set to 0.06 or less as illustrated in FIG. 22. In this case, the efficiency v can be suppressed to 60% or less in a case where the radiation angle sum is 14° or more.

FIG. 23 is a view illustrating a relationship between a numerical aperture and a light intensity distribution. In laser light emitted from the LD, regardless of the numerical aperture (NA), a light intensity distribution (near field pattern) of a lens opening portion shows a horizontally long ellipse, and a light intensity distribution (far field pattern) of a projection portion shows a vertically long ellipse as illustrated in FIG. 23. FIG. 23 illustrates an example in which the NA is set to 0.248, 0.125, and 0.083. As can be seen from FIG. 23, spot diameters in longitudinal cross sections of both the lens opening portion and the projection portion can be decreased as the NA decreases. As can be seen from FIG. 23, spot diameters in lateral cross sections of both the lens opening portion and the projection portion can be decreased as the NA decreases (however, there is no difference between the case where the NA is 0.125 and the case where the NA is 0.083).

### (Example)

As a specific example of the light source device (for example, Configuration Example 1 of the light source device) and the image display device (for example, Configuration Examples 1 and 2 of the image display device) according to the present technology, a lens having an NA of 0.06 and an LD having a radiation angle sum of 29° were used. As a result, the efficiency v could be reduced to 8%. That is, safety in image viewing with direct retinal projection could be ensured without using an ND filter, and an effect of increasing resolution of a projection image was obtained in the image viewing. It was confirmed that unnecessary stray light that did not pass through the lens was generated by using the lens with the small NA in this example. As a countermeasure, a housing to be used is subjected to anti-reflection processing (surface roughness processing or application of an absorbing material) and an aperture (opening member) corresponding to a lens opening portion is installed to reduce an influence of the unnecessary light on image light, and an object can be achieved without reducing the viewing experience value.

### 6. Feature 3 of Present Technology

### (Setting of Numerical Aperture)

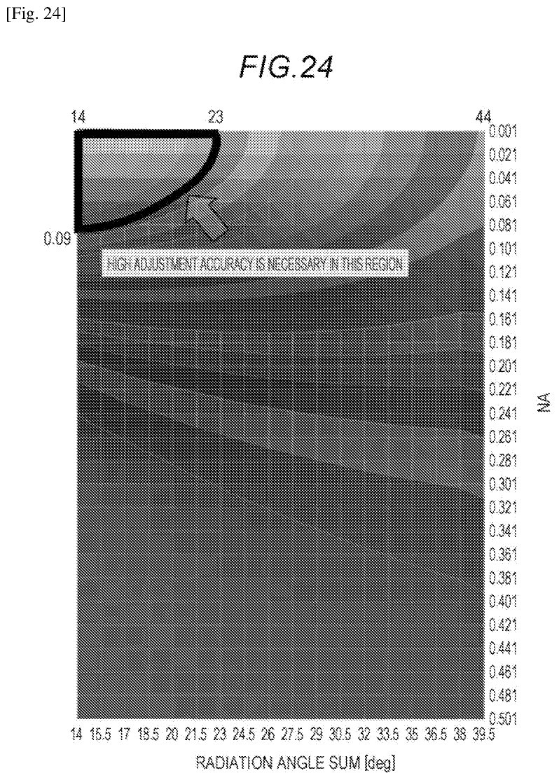

FIG. 24 is a view (Part 3) illustrating a relationship among a radiation angle sum, a numerical aperture, and efficiency. In FIG. 24, the horizontal axis represents the radiation angle sum [deg], and the vertical axis represents the numerical aperture (NA). FIG. 24 is a view similar to FIGS. 19 and 22 except that a setting range of the numerical aperture is different and the efficiency v is not indicated.

In FIG. 24, a region surrounded by a thick black line is a region requiring high adjustment accuracy. The region is a region in a figure having three coordinates of (14°, 0.001), (14°, 0.09), and (23°, 0.001) as vertices when xy coordinates (x, y) with the radiation angle sum on the x axis and the NA on the y axis are set.

When (x, y) is within the region, adjustment sensitivity becomes very high, and a light amount change with respect to a positional deviation and an angular deviation between a light source and a lens becomes very large. Therefore, it is desirable that (x, y) be a combination that deviates from the region with a smaller value of y (NA) in order to reduce the adjustment sensitivity while achieving a decrease in efficiency and resolution enhancement.

For example, it is preferable that y (numerical aperture) be 0.09 or less and x (radiation angle sum) be 14° or more. In this case, suitable (x, y) outside the region can be selected.

For example, the numerical aperture may be 0.16 or less, and the radiation angle sum may be 23° or more. In this case as well, more suitable (x, y) outside the region can be selected.

For example, the numerical aperture may be 0.09 or less, and the radiation angle sum may be 23° or more. In this case as well, even more suitable (x, y) outside the region can be selected.

### 7. Adjustment Sensitivity

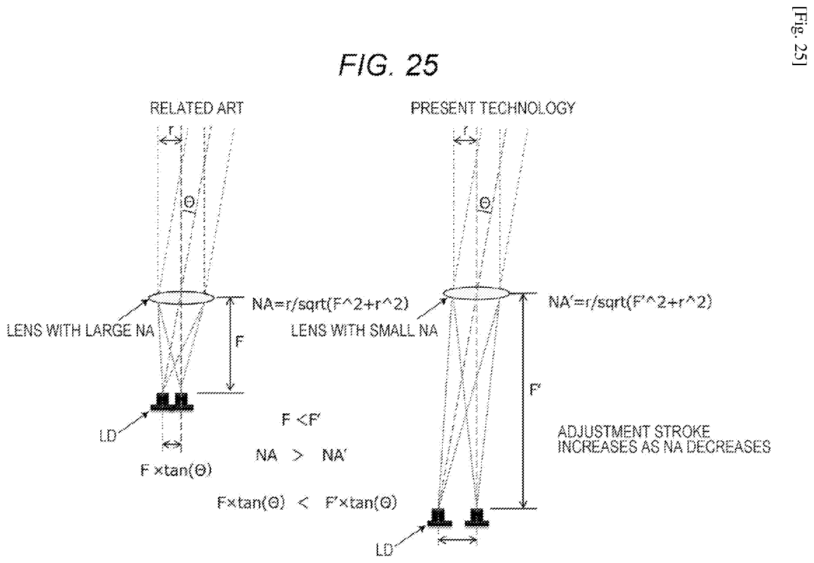

FIG. 25 is a view illustrating a positional relationship between a light source (LD) and a lens in each of a light source device of related art and the light source device of the present technology. As illustrated in FIG. 25, in the present technology, a numerical aperture of the lens is smaller (NA<NA′) and a focal length is longer (F<F′), and an adjustment stroke between the LD and the lens becomes larger (F×tan θ<F′×tan θ) as compared with related art. That is, in the present technology, a positional deviation allowable range, which is an allowable range of a positional deviation between the LD and the lens in which the entire light from the LD converges in the lens, is wider, and robustness is higher as compared with related art. Note that, in a case where the positional deviation between the LD and the lens exceeds the positional deviation allowable range, for example, tilt adjustment (angle adjustment) can be performed for correction.

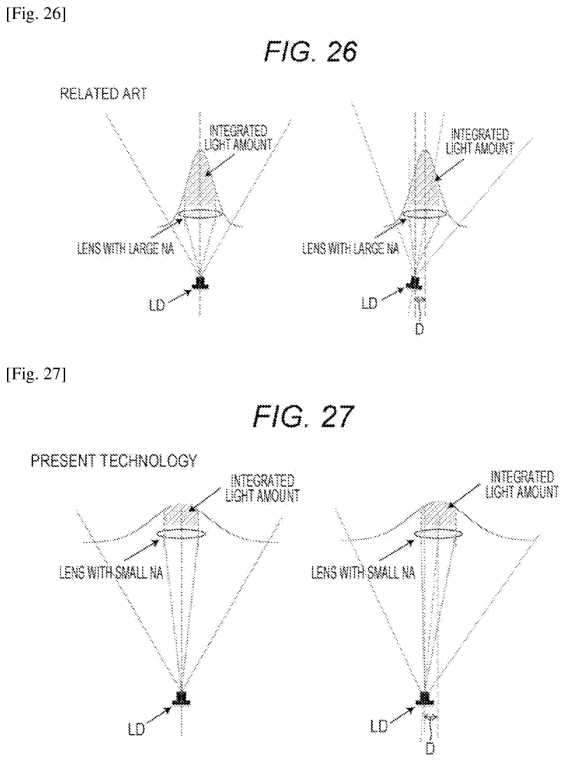

FIG. 26 is a view for describing adjustment sensitivity (in a case where a positional deviation and an angular deviation are small) of the light source device of related art. The left view in FIG. 26 illustrates an ideal state in which an optical axis of the LD and an optical axis of the lens (lens having a large NA) coincide (there is no positional deviation and angular deviation). The right view in FIG. 26 illustrates a state (tilt adjustment state) in which a small positional deviation D exceeding the allowable range described above occurs between the optical axis of the LD and the optical axis of the lens (lens having a large NA), and the optical axis of the LD is tilted by a small angle so as to pass through the center of the lens. When the left view and the right view in FIG. 26 are compared, it can be seen that a difference in an integrated light amount of light transmitted through the lens is small. That is, in the light source device of related art, a light amount change with respect to the small positional deviation D and the small angular deviation is small.

FIG. 27 is a view for describing adjustment sensitivity (in a case where a positional deviation and an angular deviation are small) of the light source device of the present technology. The left view of FIG. 27 illustrates an ideal state in which an optical axis of the LD and an optical axis of the lens (lens having a small NA) coincide. The right view in FIG. 27 illustrates a state (tilt adjustment state) in which a small positional deviation D occurs between the optical axis of the LD and the optical axis of the lens (lens having a small NA), and the optical axis of the LD is tilted by a small angle so as to pass through the center of the lens. When the left view and the right view in FIG. 27 are compared, it can be seen that a difference in an integrated light amount of light transmitted through the lens is large. That is, in the light source device of the present technology, a light amount change with respect to the small positional deviation D and the small angular deviation is large.

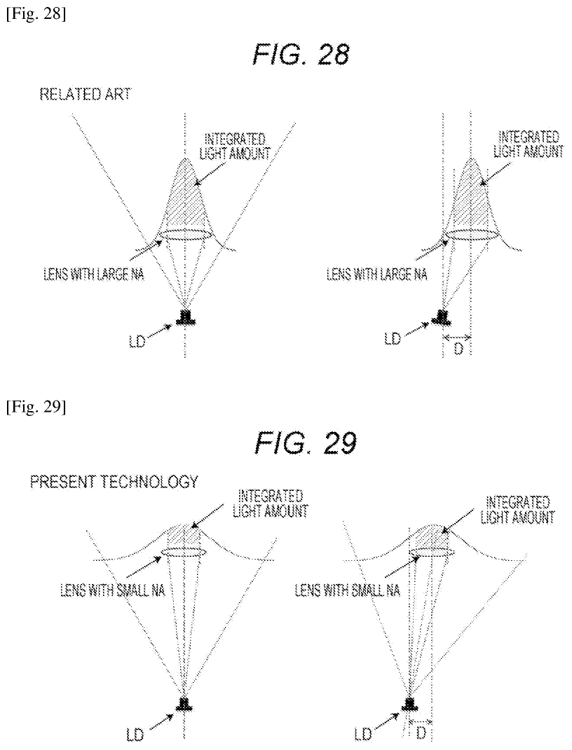

FIG. 28 is a view for describing adjustment sensitivity (in a case where a positional deviation and an angular deviation are large) of the light source device of related art. The left view in FIG. 28 illustrates an ideal state in which an optical axis of the LD and an optical axis of the lens (lens having a large NA) coincide (there is no positional deviation and angular deviation). The right view in FIG. 28 illustrates a state (tilt adjustment state) in which a large positional deviation D occurs between the optical axis of the LD and the optical axis of the lens (lens having a large NA), and the optical axis of the LD is tilted by a large angle so as to pass through the center of the lens. When the left view and the right view in FIG. 28 are compared, it can be seen that a difference in an integrated light amount of light transmitted through the lens is small. That is, in the light source device of related art, a light amount change with respect to the large positional deviation and the large angular deviation is small.

FIG. 29 is a view for describing adjustment sensitivity (in a case where a positional deviation and an angular deviation are small) of the light source device of the present technology. The left view of FIG. 29 illustrates an ideal state in which an optical axis of the LD and an optical axis of the lens (lens having a small NA) coincide. The right view in FIG. 29 illustrates a state (tilt adjustment state) in which a large positional deviation D occurs between the optical axis of the LD and the optical axis of the lens (lens having a small NA), and the optical axis of the LD is tilted by a large angle so as to pass through the center of the lens. When the left view and the right view in FIG. 29 are compared, it can be seen that a difference in an integrated light amount of light transmitted through the lens is large. That is, in the light source device of the present technology, a light amount change with respect to the large positional deviation and the large angular deviation is large.

As can be seen from the above description, for example, in a case where the positional deviation between the LD and the lens exceeds the positional deviation allowable range and the tilt adjustment is performed, the light amount change due to the angular deviation between the LD and the lens is larger in the present technology using the lens having a small NA as compared with related art using the lens having a large NA. It is considered that this light amount change increases as the NA decreases and the radiation angle sum decreases. In particular, this light amount change is very large in the region surrounded by the thick black line in FIG. 24, and thus it is very effective to set the NA and the radiation angle sum such that a combination of the NA and the radiation angle sum does not fall within the region.

### 8. Configuration Examples 3 to 5 of Image Display Device According to Present Technology

### (Configuration Example 3 of Image Display Device)

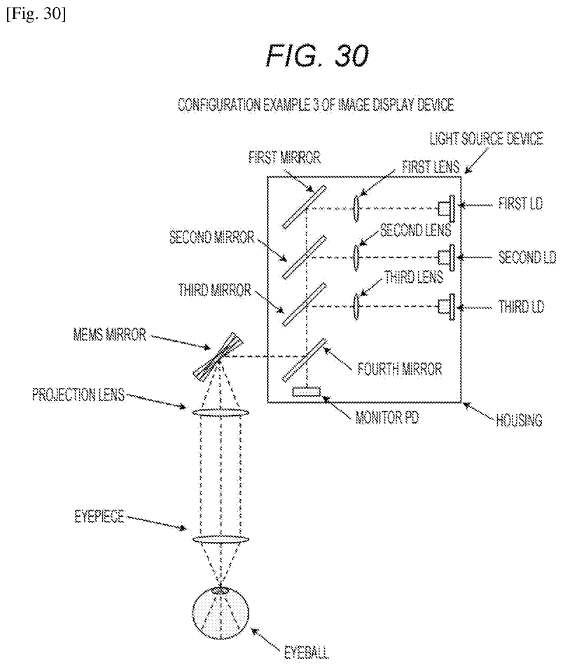

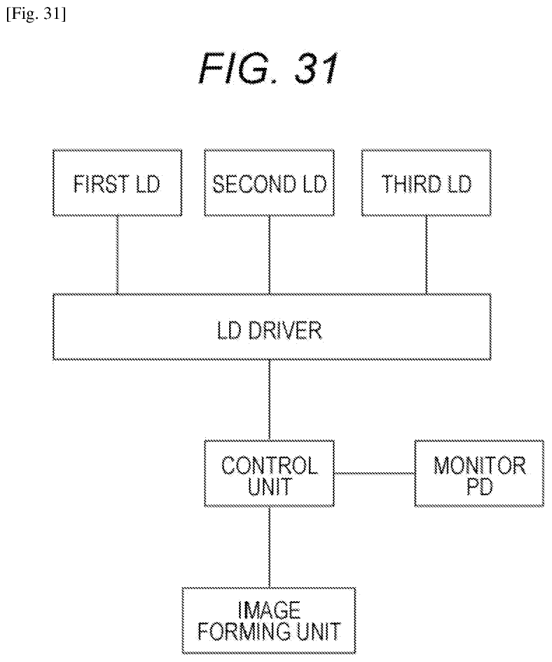

FIG. 30 is a view illustrating Configuration Example 3 of the image display device according to the present technology. FIG. 31 is a block diagram illustrating functions of the image display device of FIG. 30. Configuration Example 3 of the image display device is an image display device for direct retinal projection. As illustrated in FIGS. 30 and 31, Configuration Example 3 of the image display device includes a light source device, a MEMS mirror (optical deflector) as an image forming unit, a projection lens as a projection optical system, an eyepiece as an ocular optical element, and a control unit. At least the ocular optical element in Configuration Example 3 of the image display device is integrally supported by a support structure (for example, a spectacle frame) mounted on a head (including a part of a face) of a user. A system including the light source device, the MEMS mirror, and the projection lens may be integrally supported by the support structure, or may be provided in a body (for example, in a stationary housing) separate from the support structure.

Configuration Example 3 of the image display device includes a plurality of (for example, three) light sources having different light emission wavelengths, a plurality of lenses is provided to correspond to the plurality of light sources, and an optical system of the light source device includes a combining unit including first to third mirrors and combining beams of light respectively emitted from the plurality of light sources and passing through the corresponding lenses.

### (Light Source Device)

The light source device of Configuration Example 3 includes first LD to third LD, first to third lenses, first to fourth mirrors, a monitor PD, an LD driver, and a housing that houses these.

The first LD to the third LD are LDs that emit red (R) light, blue (G) light, and green (B) light, respectively. A radiation angle sum of each of the LDs is 14° or more. Each of the lenses is a lens (for example, a spherical lens or an aspherical lens) having an NA of 0.16 or less. Each of the lenses is, for example, a collimator lens (also referred to as a collimating lens).

The first lens is disposed on an optical path of red light emitted from the first LD. The first mirror is a dichroic mirror that reflects red light. The first mirror is disposed on an optical path of red light emitted from the first LD and transmitted through the first lens.

The second lens is disposed on an optical path of green light emitted from the second LD. The second mirror is a dichroic mirror that transmits red light and reflects green light. The second mirror is disposed at an intersection between an optical path of red light reflected from the first mirror and an optical path of green light emitted from the second LD and transmitted through the second lens.

The third lens is disposed on an optical path of blue light emitted from the third LD. The third mirror is a dichroic mirror that transmits red light and green light and reflects blue light. The third mirror is disposed at an intersection between an optical path of combined light of red light and green light passing through the second mirror and an optical path of blue light emitted from the third LD and transmitted through the third lens.

The combined light of red light, green light, and blue light passing through the third mirror is incident on the fourth mirror. The fourth mirror is a half mirror that transmits a part of the incident light and reflects the other part. The monitor PD is disposed on an optical path of the light transmitted through the fourth mirror. The monitor PD includes, for example, a photodiode (PD).

The LD driver includes, for example, circuit elements such as a capacitor and a transistor.

### (Image Forming Unit)

The MEMS mirror as the image forming unit is disposed on an optical path of the combined light reflected by the fourth mirror, and forms an image with the combined light. The MEMS mirror includes a mirror portion rotatable about two different axes. The MEMS mirror is controlled by the control unit (also called a controller) in synchronization with the LDs. Note that the housing is provided with a light transmission window that transmits the combined light, reflected by the fourth mirror, toward the MEMS mirror.

The control unit generates a light emission control signal for causing each of the LDs to emit light on the basis of input image information, and outputs the light emission control signal to the LD driver. The LD driver generates a drive signal for driving each of the LDs on the basis of the light emission control signal, and applies the drive signal to the corresponding LD. The control unit controls a light emission amount of the LD on the basis of an output signal of the monitor PD (APC: auto power control). The control unit includes, for example, a CPU, an FPGA, a chip set, and the like.

### (Projection Optical System)

The projection lens may be part of a projection optical system that projects light forming an image from the MEMS mirror. More specifically, the projection lens is disposed on an optical path of light deflected by the MEMS mirror, and converts the light into substantially parallel light.

### (Ocular Optical Element)

The ocular optical element is disposed on an optical path of the light converted into the substantially parallel light by the projection lens, and guides the light passing through the projection optical system to an eyeball of the user. For example, the eyepiece is used as the ocular optical element.

In Configuration Example 3 of the image display device described above, it is possible to provide a full-color image display device that exhibits effects similar to those of Configuration Examples 1 and 2 of the image display device.

### (Configuration Example 4 of Image Display Device)

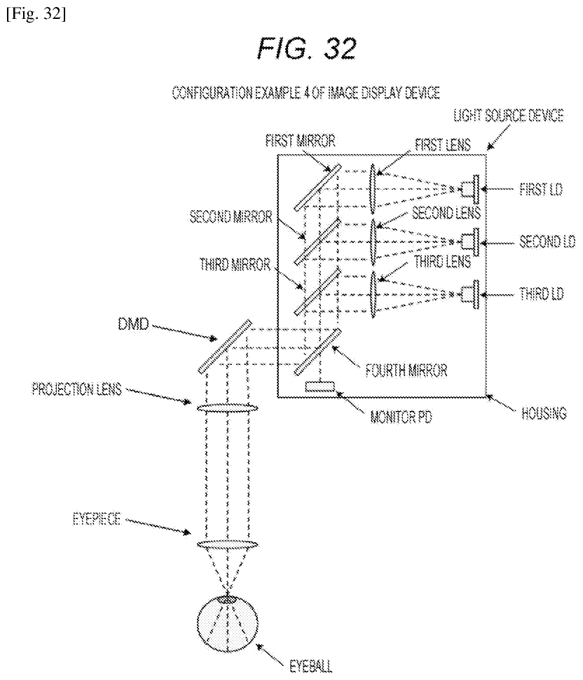

FIG. 32 is a view illustrating Configuration Example 4 of the image display device according to the present technology. Configuration Example 4 of the image display device is an image display device for direct retinal projection. As illustrated in FIG. 32, Configuration Example 4 of the image display device has configurations similar to those of Configuration Example 3 of the image display device except that an image forming unit includes a DMD (digital micromirror device) instead of the MEMS mirror. Configuration Example 4 of the image display device has effects similar to those of Configuration Example 3 of the image display device described above.

### (Configuration Example 5 of Image Display Device)

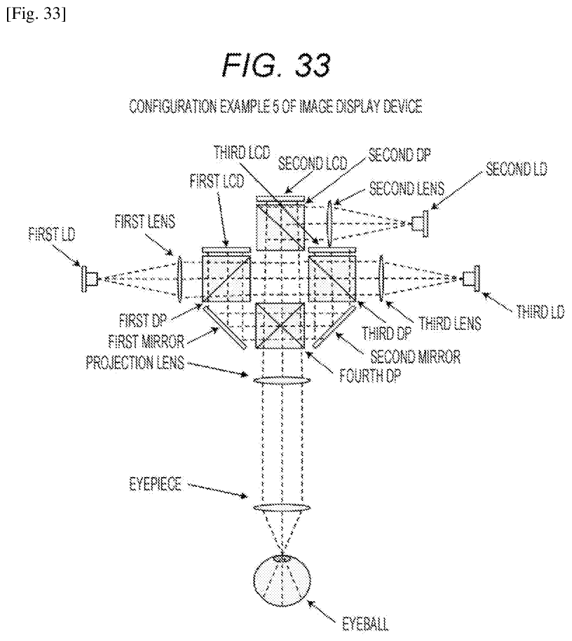

FIG. 33 is a view illustrating Configuration Example 5 of the image display device according to the present technology. Configuration Example 5 of the image display device is an image display device for direct retinal projection. Configuration Example 5 of the image display device has configurations similar to those of Configuration Example 3 of the image display device except that a plurality of LCDs as liquid crystal elements is provided to correspond to a plurality of (for example, three) lenses, and an image forming unit causes light passing through each of the plurality of lenses to be incident on the liquid crystal element corresponding to the lens and combines the light passing through the liquid crystal element as illustrated in FIG. 33.

In Configuration Example 5 of the image display device, a light source device includes first to third LDs and first to third lenses, and the image forming unit includes first to fourth dichroic prisms (DPs), first to third (liquid crystal displays (LCDs), and first and second mirrors.

The first DP (first dichroic prism) that reflects red light emitted from the first LD and passing through the first lens is disposed on an optical path of the red light. The first LCD (first liquid crystal display) is disposed on an optical path of the red light reflected by the first DP. The first LCD is a reflective liquid crystal element, and forms an image with incident red light. The red light, which has been reflected by the first LCD and formed the image, is transmitted through the first DP, reflected by the first mirror, and incident on the fourth DP (cross dichroic prism).

The second DP (second dichroic prism) that reflects green light emitted from the second LD and passing through the second lens is disposed on an optical path of the green light. The second LCD (second liquid crystal display) is disposed on an optical path of the green light reflected by the second DP. The second LCD is a reflective liquid crystal element, and forms an image with incident green light. The green light, which has been reflected by the second LCD and formed the image, is transmitted through the second DP and incident on the fourth DP.

The third DP (third dichroic prism) that reflects blue light emitted from the third LD and passing through the third lens is disposed on an optical path of the blue light. The third LCD (third liquid crystal display) is disposed on an optical path of the blue light reflected by the third DP. The third LCD is a reflective liquid crystal element, and forms an image with incident blue light. The blue light, which has been reflected by the third LCD and formed the image, is transmitted through the third DP, reflected by the second mirror, and incident on the fourth DP.

The cross dichroic prism serving as the fourth DP combines the red light passing through the first mirror, the green light passing through the second DP, and the blue light passing through the second mirror, and emits combined light thereof.

A projection lens as a projection optical element is disposed on an optical path of the combined light from the fourth DP. An eyepiece as an ocular optical element is disposed on an optical path of the combined light passing through the projection lens.

Configuration Example 5 of the image display device described above has effects similar to those of Configuration Example 3 of the image display device.

### 9. Volumes of Light Source Device According to Present Technology and Light Source Device of Related Art

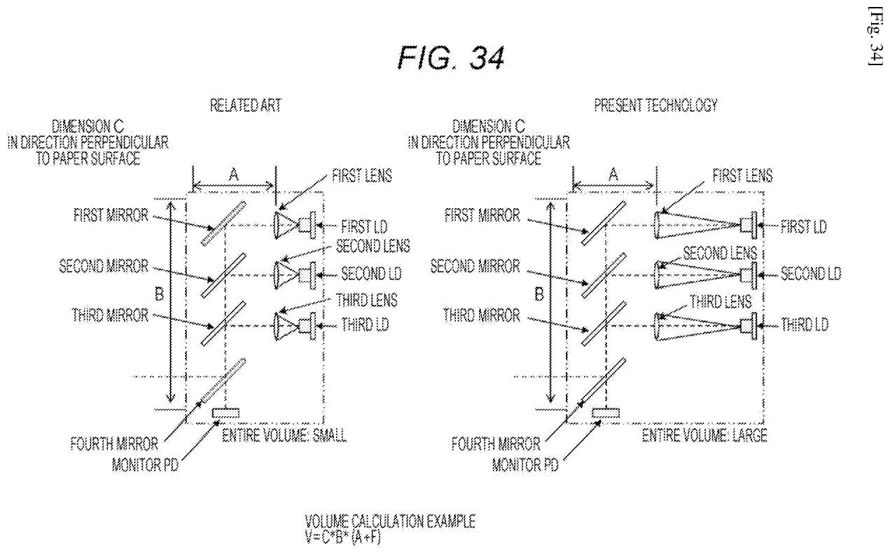

FIG. 34 is a view for comparing volumes of the light source device of related art and the light source device of the present technology. The light source device of the present technology illustrated in the right view of FIG. 34 has a configuration similar to that of the light source device in Configuration Examples 3 and 4 of the image display device (configuration in which NAs of first to third lenses are 0.16 or less). The light source device of related art illustrated in the left view of FIG. 34 has configurations substantially similar to those of the light source device in Configuration Examples 3 and 4 of the image display device except that NAs of first to third lenses are more than 0.16. The device volume of the light source device can be expressed as V=C×B×(A+F) using dimensions A and B in FIG. 34, a dimension C in a direction perpendicular to the paper surface, and a focal length F of each of the lenses. Thus, the focal length of each of the lenses of the light source device of the present technology is longer than the focal length of each of the lenses of the light source device of related art, and the device volume increases accordingly. Therefore, it is preferable to set the NA to, for example, 0.03 or more in order to suppress the focal length as described above.

### 10. Image Display Devices According to First to Ninth Embodiments of Present Technology

Hereinafter, image display devices according to first to ninth embodiments of the present technology will be described.

### (Image Display Device According to First Embodiment)

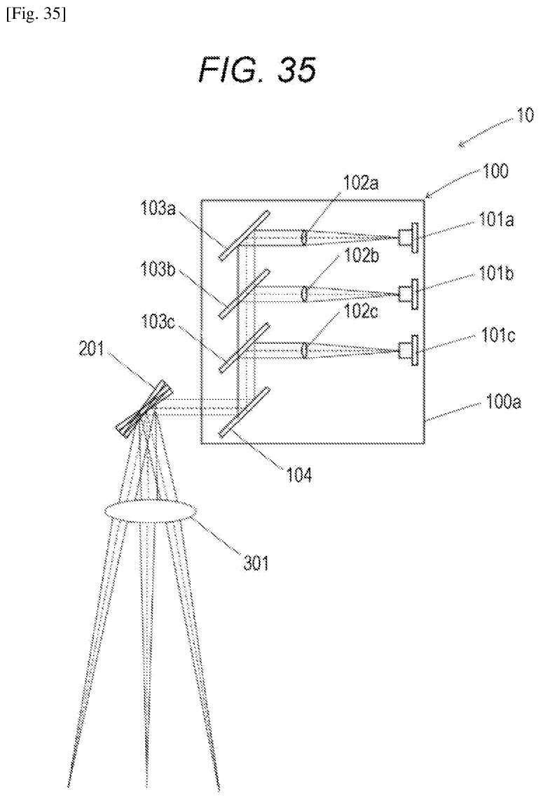

FIG. 35 is a view illustrating an image display device 10 according to the first embodiment of the present technology. The image display device 10 is a projector. As illustrated in FIG. 35, the image display device 10 has configurations substantially similar to those of Configuration Example 3 (see FIG. 30) of the image display device except that an eyepiece and a monitor PD are not provided. The image display device 10 includes a light source device 100, a MEMS mirror 201, and a projection lens 301. The light source device 100 includes first to third LDs 101a, 101b, and 101c, first to third lenses 102a, 102b, and 102c, first to fourth mirrors 103a, 103b, 103c, and 104, and a housing 100a that houses these. Light emitted from the light source device 100 and passing through the MEMS mirror 201 and the projection lens 301 in this order forms an image on a predetermined display surface (for example, a screen surface, a wall surface of a building, or a ceiling surface). Note that the image display device 10 may include a monitor PD (see FIG. 30). According to the image display device 10, it is possible to provide a projector capable of coping with an excessive amount of light of the LD (particularly suitable for use in a dark environment) and capable of high-resolution display.

### (Image Display Device According to Second Embodiment)

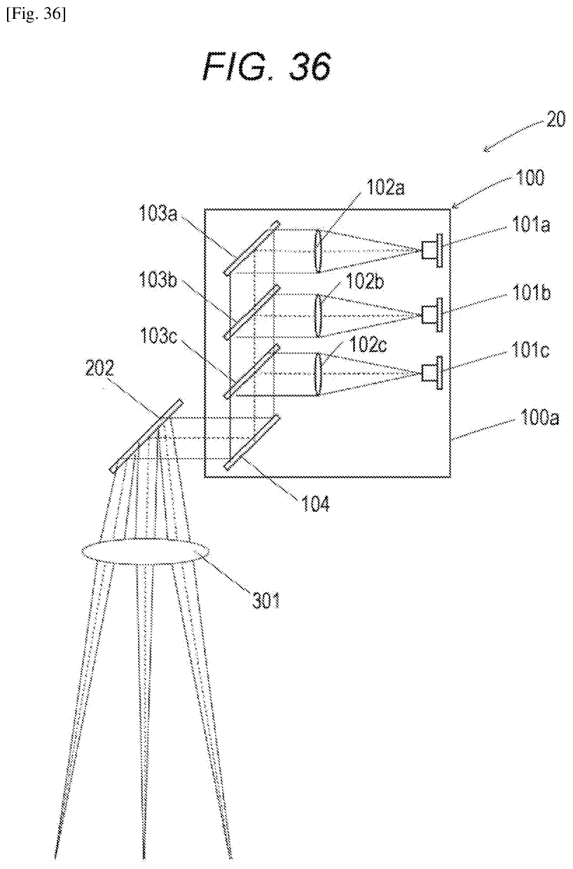

FIG. 36 is a view illustrating an image display device 20 according to the second embodiment of the present technology. The image display device 20 is a projector. As illustrated in FIG. 36, the image display device 20 has configurations substantially similar to those of Configuration Example 4 (see FIG. 32) of the image display device except that an eyepiece and a monitor PD are not provided. The image display device 20 includes a light source device 100, a digital mirror device (DMD) 202, and a projection lens 301. Light emitted from the light source device 100 and passing through the DMD 202 and the projection lens 301 in this order forms an image on a predetermined display surface (for example, a screen surface, a wall surface of a building, or a ceiling surface). Note that the image display device 20 may include a monitor PD (see FIG. 32). According to the image display device 20, it is possible to provide a projector capable of coping with an excessive amount of light of the LD (particularly suitable for use in a dark environment) and capable of high-resolution display.

### (Image Display Device According to Third Embodiment)

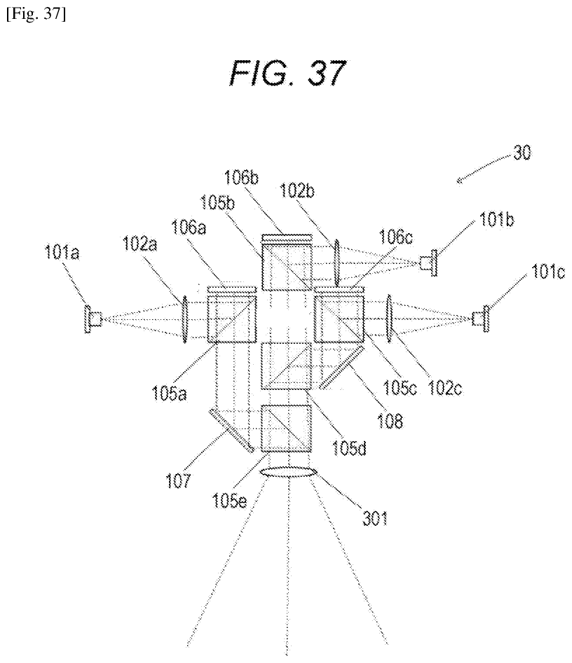

FIG. 37 is a view illustrating an image display device 30 according to the third embodiment of the present technology. The image display device 30 is a projector. As illustrated in FIG. 37, the image display device 30 has configurations substantially similar to those of Configuration Example 5 (see FIG. 33) of the image display device except that an eyepiece is not provided and five dichroic prisms are provided. A light source device of the image display device 30 includes first to third LDs 101a, 101b, and 101c and first to third lenses 102a, 102b, and 102c. An image forming unit of the image display device 30 includes first to fifth dichroic prisms 105a, 105b, 105c, 105d, and 105e, first to third LCDs 106a, 106b, and 106c, and first and second mirrors 107 and 108. A projection optical system of the image display device 30 includes a projection lens 301.

Red light, which has been emitted from the first LD 101a and transmitted through the first lens 102a, is reflected by the first dichroic prism 105a toward the first LCD 106a. The red light, which has been reflected by the first LCD 106a and formed an image, is reflected by the first mirror 107 and incident on the fifth dichroic prism 105e.

Green light, which has been emitted from the second LD 101b and transmitted through the second lens 102b, is reflected by the second dichroic prism 105b toward the second LCD 106b. The green light, which has been reflected by the second LCD 106b and formed an image, is transmitted through the fourth dichroic prism 105d and incident on the fifth dichroic prism 105e.

Blue light, which has been emitted from the third LD 101c and transmitted through the third lens 102c, is reflected by the third dichroic prism 105c toward the third LCD 106c. The blue light, which has been reflected by the third LCD 106c and formed an image, is reflected by the second mirror 108, reflected by the fourth dichroic prism 105d, and incident on the fifth dichroic prism 105e.

The red light, the green light, and the blue light incident on the fifth dichroic prism 105e are combined by the fifth dichroic prism 105e and form an image on a predetermined display surface (for example, a screen surface, a wall surface of a building, or a ceiling surface) through the projection lens 301.

According to the image display device 30 described above, it is possible to provide a projector capable of coping with an excessive amount of light of the LD (particularly suitable for use in a dark environment) and capable of high-resolution display.

### (Image Display Device According to Fourth Embodiment)

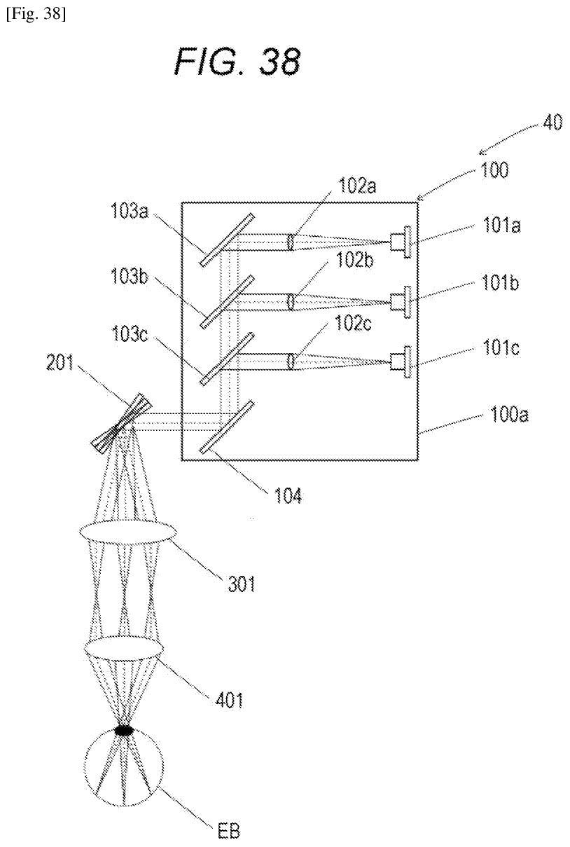

FIG. 38 is a view illustrating an image display device 40 according to the fourth embodiment of the present technology. The image display device 40 is an image display device for direct retinal projection. As illustrated in FIG. 38, the image display device 40 has configurations substantially similar to those of the image display device 10 (see FIG. 35) according to the first embodiment except that an eyepiece 401 is provided.

In the image display device 40, light passing through a projection lens 301 forms an intermediate image formation point on an optical path between the projection lens 301 and the eyepiece 401. Light passing through the eyepiece 401 forms an image on a retina of an eyeball EB.

According to the image display device 40, it is possible to provide the image display device for direct retinal projection capable of coping with an excessive amount of light of an LD (particularly contributing to eye safety) and capable of high-resolution display.

### (Image Display Device According to Fifth Embodiment)

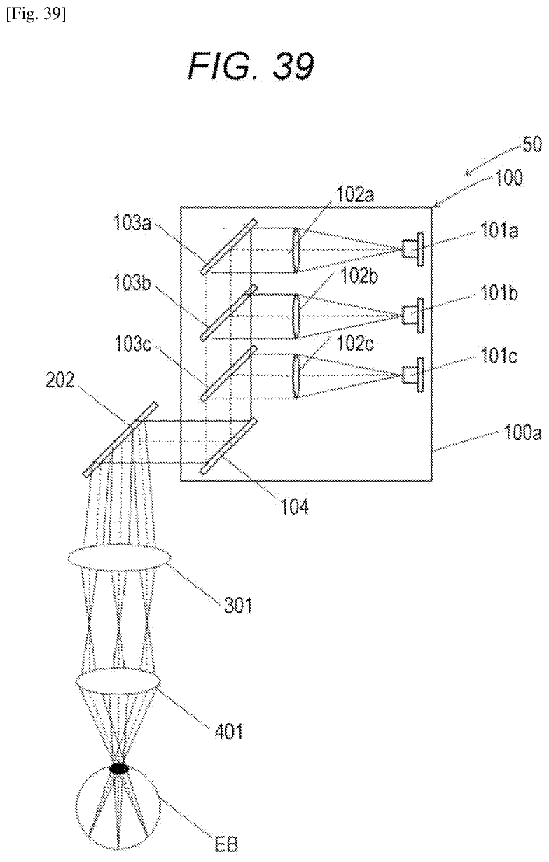

FIG. 39 is a view illustrating an image display device 50 according to the fifth embodiment of the present technology. The image display device 50 is an image display device for direct retinal projection. As illustrated in FIG. 39, the image display device 50 has configurations substantially similar to those of the image display device 20 (see FIG. 36) according to the second embodiment except that an eyepiece 401 is provided.

In the image display device 50, light passing through a projection lens 301 forms an intermediate image formation point on an optical path between the projection lens 301 and the eyepiece 401. Light passing through the eyepiece 401 forms an image on a retina of an eyeball EB.

According to the image display device 50, it is possible to provide the image display device for direct retinal projection capable of coping with an excessive amount of light of an LD (particularly contributing to eye safety) and capable of high-resolution display.

### (Image Display Device According to Sixth Embodiment)

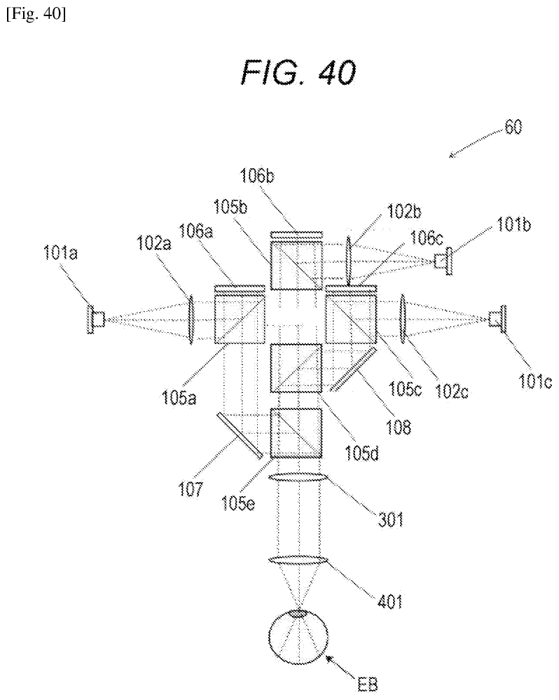

FIG. 40 is a view illustrating an image display device 60 according to the sixth embodiment of the present technology. The image display device 60 is an image display device for direct retinal projection. As illustrated in FIG. 40, the image display device 60 has configurations substantially similar to those of the image display device 30 (see FIG. 37) according to the third embodiment except that an eyepiece 401 is provided as an ocular optical element. In the image display device 60, light passing through a projection lens 301 as a projection optical system forms an image on a retina of an eyeball EB through the eyepiece 401.

According to the image display device 60, it is possible to provide the image display device for direct retinal projection capable of coping with an excessive amount of light of an LD (particularly contributing to eye safety) and capable of high-resolution display.

### (Image Display Device According to Seventh Embodiment)

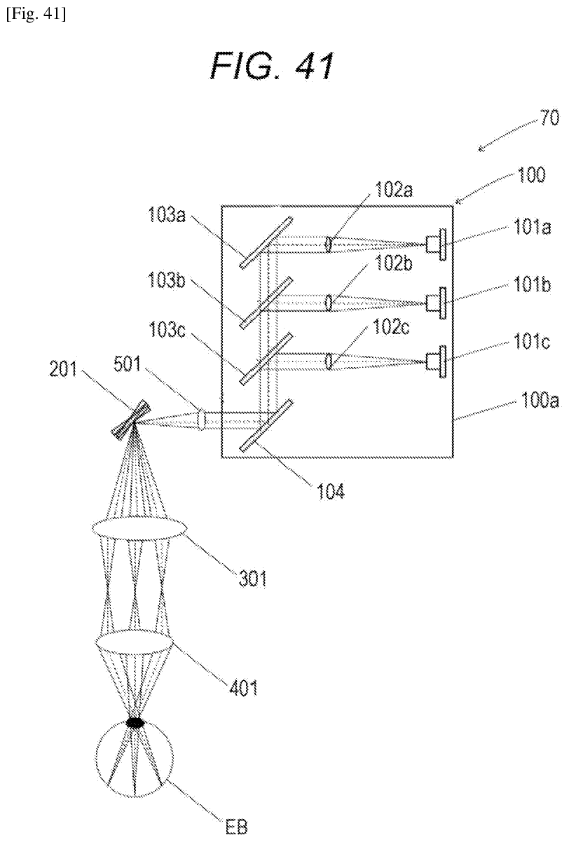

FIG. 41 is a view illustrating an image display device 70 according to the seventh embodiment of the present technology. The image display device 70 is an image display device for direct retinal projection. As illustrated in FIG. 41, the image display device 70 has configurations substantially similar to those of the image display device 40 (see FIG. 38) according to the fourth embodiment except that a condensing optical element 501 disposed on an optical path of light between a light source device 100 and a MEMS mirror 201, which is an image forming unit, is further provided.

The condensing optical element 501 condenses (images) light from the light source device 100 on the MEMS mirror 201. Therefore, it is possible to further increase resolution of an image formed on a retina of an eyeball EB. Furthermore, the MEMS mirror 201 having a small size can be used. As the condensing optical element 501, for example, a condensing mirror can be used in addition to a condensing lens.

According to the image display device 70, it is possible to provide the image display device for direct retinal projection capable of coping with an excessive amount of light of an LD (particularly contributing to eye safety) and capable of higher-resolution display.

### (Image Display Device According to Eighth Embodiment)

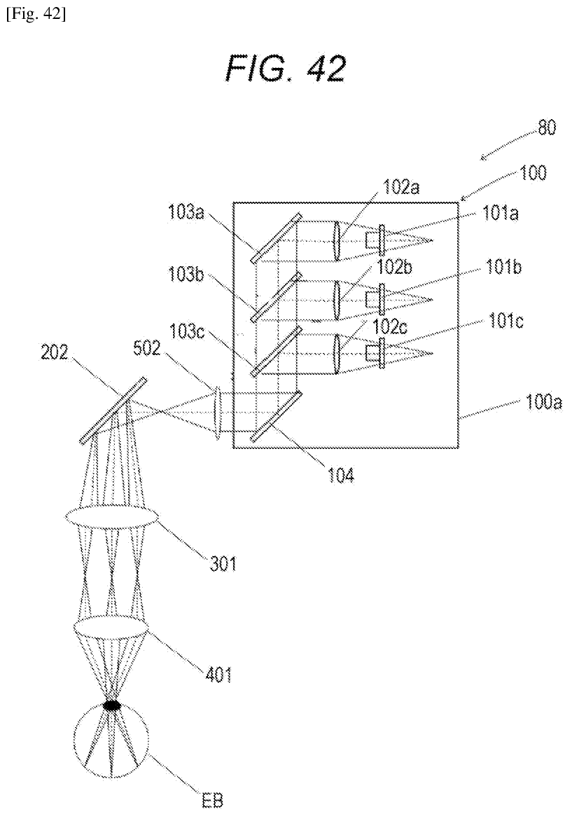

FIG. 42 is a view illustrating an image display device 80 according to the eighth embodiment of the present technology. The image display device 80 is an image display device for direct retinal projection. As illustrated in FIG. 42, the image display device 80 has configurations substantially similar to those of the image display device 50 (see FIG. 39) according to the fifth embodiment except that a condensing optical element 502 disposed on an optical path of light between a light source device 100 and a DMD 202, which is an image forming unit, is further provided.

The condensing optical element 502 condenses (images) light from the light source device 100 on an optical path of light between the condensing optical element 502 and the DMD 202, and causes the light to be incident on the DMD 202 as diffused light. Therefore, it is possible to further increase resolution of an image formed on a retina of an eyeball EB. As the condensing optical element 501, for example, a condensing mirror can be used in addition to a condensing lens.

According to the image display device 70, it is possible to provide the image display device for direct retinal projection capable of coping with an excessive amount of light of an LD (particularly contributing to eye safety) and capable of higher-resolution display.

### (Image Display Device According to Ninth Embodiment)

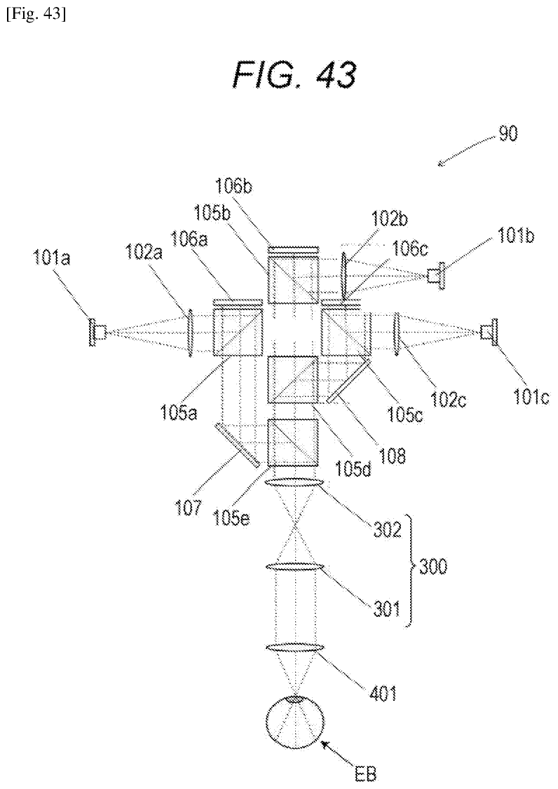

FIG. 43 is a view illustrating an image display device 90 according to the ninth embodiment of the present technology. The image display device 90 is an image display device for direct retinal projection. As illustrated in FIG. 43, the image display device 90 has configurations substantially similar to those of the image display device 60 (see FIG. 40) according to the sixth embodiment except that a projection optical system 300 includes a condensing optical element 302 in addition to a projection lens 301.

In the image display device 90, the condensing optical element 302 is disposed between an image forming unit and the projection lens 301. The condensing optical element 302 condenses (images) light forming an image from the image forming unit on an optical path between the condensing optical element 302 and the projection lens 301 to form an intermediate image formation point. Diffused light from the intermediate image formation point is converted into substantially parallel light by the projection lens 301, and forms an image on a retina of an eyeball EB through an eyepiece 401. Examples of the condensing optical element 302 include a condensing lens and a condensing mirror.

In the image display device 90, the intermediate image formation point is formed in the projection optical system 300, and thus, it is possible to further increase resolution of the image projected on the retina of the eyeball EB. As the condensing optical element 302, for example, a condensing mirror can be used in addition to a condensing lens.

According to the image display device 90, it is possible to provide the image display device for direct retinal projection capable of coping with an excessive amount of light of an LD (particularly contributing to eye safety) and capable of higher-resolution display.

Note that the condensing optical element 302 in the image display device 90 may be disposed on an optical path of light between the projection lens 301 and the eyepiece 401.

### 11. Modified Examples of Present Technology

Configuration Example 1 of the light source device described above, the respective configuration examples of the image display device described above, and the image display devices according to the respective embodiments can be appropriately changed.

For example, the reflective LCD is used as each of the liquid crystal elements in the image forming unit in Configuration Example 5 of the image display device, the image display device 30 according to the third embodiment, the image display device 60 according to the sixth embodiment, and the image display device 90 according to the ninth embodiment, but a transmissive LCD can also be used as at least one liquid crystal element.

For example, a contact lens type optical element to be mounted on the eyeball EB may be used instead of or in addition to the ocular optical element (for example, eyepiece) in the image display device for direct retinal projection. In this case, the contact lens type optical element may be a component of the image display device or is not necessarily a constituent element of the image display device. As the contact lens type optical element, for example, a diffractive optical element (DOE), a hologram optical element (HOE), or the like can be used.

For example, the light source of the light source device or the image display device is not limited to the semiconductor laser, and may be any light source that can define the radiation angle, such as a light emitting diode, a halogen lamp, or lasers other than the semiconductor laser. In this case as well, it is preferable to set the radiation angle sum to 14° or more.

For example, a galvano mirror or the like may be used instead of the MEMS mirror as the optical deflector of the image forming unit.

For example, an eyepiece mirror may be used as the ocular optical element instead of the eyepiece.

For example, a projection mirror may be used instead of the projection lens as the projection optical element of the projection optical system.

For example, Configuration Example 1 of the light source device, the respective configuration examples of the image display device, and the image display devices according to the respective embodiments may be combined with each other within a range that does not cause any inconsistency.

Note that the present technology can also have the following configurations.
(1) A light source device including:
at least one light source; and
an optical system disposed on an optical path of light from the light source and including a lens,
in which the lens has a numerical aperture of 0.16 or less, and the light source has a radiation angle sum of 14° or more, the radiation angle sum being a sum of radiation angles respectively related to two directions orthogonal to each other.
(2) The light source device according to (1), in which the numerical aperture is 0.09 or less, and the radiation angle sum is 14° or more.
(3) The light source device according to one or more of (1) to (2), in which the numerical aperture is 0.16 or less, and the radiation angle sum is 23° or more.
(4) The light source device according to one or more of (1) to (3), in which the numerical aperture is 0.09 or less, and the radiation angle sum is 23° or more.
(5) The light source device according to one or more of (1) to (4), in which the lens is a spherical lens or an aspherical lens.
(6) The light source device according to one or more of (1) to (5), in which the light source is a semiconductor laser.
(7) An image display device including: the light source device according to one or more of (1) to (6); an image forming unit that forms an image with light from the light source device; and a projection optical system that projects the light forming the image.
(8) The image display device according to one or more of (1) to (7), in which the image forming unit includes an optical deflector.
(9) The image display device according to one or more of (1) to (8), in which the image forming unit includes a digital mirror device.
(10) The image display device according to one or more of (1) to (9), in which the image forming unit includes a liquid crystal element.
(11) The image display device according to one or more of (1) to (10), in which the at least one light source is a plurality of the light sources having different light emission wavelengths, a plurality of the lenses is provided to correspond to the plurality of light sources, and the optical system of the light source device combines beams of light respectively emitted from the plurality of light sources and passing through the corresponding lenses.
(12) The image display device according to one or more of (1) to (11), in which the at least one light source is a plurality of the light sources having different light emission wavelengths, a plurality of the lenses is provided to correspond to the plurality of light sources, a plurality of the liquid crystal elements is provided to correspond to the plurality of lenses, and the image forming unit causes beams of light passing through the plurality of lenses to be incident on the liquid crystal elements corresponding to the lenses, respectively, and combines beams of light passing through the liquid crystal elements.
(13) The image display device according to one or more of (1) to (12), further including an optical element that guides light passing through the projection optical system to an eyeball of a user.
(14) The image display device according to one or more of (1) to (13), further including a condensing optical element disposed on the optical path of the light between the light source device and the image forming unit.
(15) The image display device according to one or more of (1) to (14), in which the image forming unit includes a digital mirror device, and the condensing optical element condenses the light on the optical path of the light between the light source device and the digital mirror device.
(16) The image display device according to one or more of (1) to (15), in which the image forming unit includes an optical deflector, and the condensing optical element condenses the light on the optical deflector.
(17) The image display device according to one or more of (1) to (16), in which the projection optical system includes a condensing optical element.
(18) The image display device according to one or more of (1) to (17), in which the projection optical system includes a projection optical element, and the condensing optical element is disposed on the optical path of the light between the image forming unit and the projection optical element.
(19) The image display device according to one or more of (1) to (17), further including an optical element that guides light passing through the projection optical system to an eyeball of a user, in which the projection optical system includes a projection optical element, and the condensing optical element is disposed on the optical path of the light between the projection optical element and the optical element.
(20) The image display device according to one or more of (1) to (19), in which at least the optical element is mounted on a head of the user.
(21)
A light source device comprising:
a light source; and
an optical system including a lens in an optical path of light from the light source,
wherein the lens has a numerical aperture of 0.16 or less, and wherein the light source has a radiation angle sum, the radiation angle sum being a sum of a first radiation angle measured with respect to a first direction and a second radiation angle measured with respect to a second direction orthogonal to the first direction.
(22)
The light source device according to (21), wherein the numerical aperture is 0.09 or less, and wherein the radiation angle sum is 14° or more.
(23)
The light source device according to one or more of (21) to (22), wherein the numerical aperture is 0.16 or less, and wherein the radiation angle sum is 23° or more.
(24)
The light source device according to one or more of (21) to (23), wherein the numerical aperture is 0.09 or less, and wherein the radiation angle sum is 23° or more.
(25)
The light source device according to one or more of (21) to (24), wherein the lens is a spherical lens or an aspherical lens.
(26)
The light source device according to one or more of (21) to (25), wherein the light source comprises a laser.
(27)
An image display device comprising:
a light source device including:
a light source; and
an optical system including a lens in an optical path of light from the light source,
wherein the lens has a numerical aperture of 0.16 or less, and wherein the light source has a radiation angle sum, the radiation angle sum being a sum of a first radiation angle measured with respect to a first direction and a second radiation angle measured with respect to a second direction orthogonal to the first direction;
an image forming system that forms an image with light from the light source device; and
a projection system that projects the image.
(28)
The image display device according to (27), wherein the image forming system includes an optical deflector.
(29)
The image display device according to one or more of (27) to (28), wherein the image forming system includes a digital mirror device.
(30)
The image display device according to one or more of (27) to (29), wherein the image forming system includes a liquid crystal element.
(31)
The image display device according to one or more of (27) to (30), further comprising:
a plurality of light sources emitting different wavelengths of light; and
a plurality of lenses that correspond to the plurality of light sources,
wherein the optical system combines light from the plurality of light sources that has passed through the corresponding lenses.
(32)
The image display device according to one or more of (27) to (31), further comprising:
a plurality of light sources emitting different wavelengths of light; and
a plurality of lenses that correspond to the plurality of light sources,
wherein the image forming system includes a plurality of liquid crystal elements that correspond to the plurality of lenses, and
wherein the image forming system causes light passing through the plurality of lenses to be incident on the plurality liquid crystal elements, and combines light that has passed through the liquid crystal elements.
(33)
The image display device according to one or more of (27) to (32), further comprising an optical element that guides light passing through the projection system to an eyeball of a user.
(34)
The image display device according to one or more of (27) to (33), further comprising a condensing optical element disposed between the light source device and the image forming system.
(35)
The image display device according to one or more of (27) to (34), wherein the image forming system includes a digital mirror device that receives light from the condensing optical element.
(36)
The image display device according to one or more of (27) to (35), wherein the image forming system includes an optical deflector that receives light from the condensing optical element.
(37)
The image display device according to one or more of (27) to (36), wherein the projection system includes a condensing optical element.
(38)
The image display device according to one or more of (27) to (37), wherein the projection system includes a projection optical element, and wherein the condensing optical element is disposed between the image forming system and the projection optical element.
(39)
The image display device according to one or more of (27) to (38), further comprising:
an optical element that guides light passing through the projection system to an eyeball of a user,
wherein the projection system includes a projection optical element, and
wherein the condensing optical element is disposed between the projection optical element and the optical element.
(40)
A light source device comprising:
a light source; and
an optical system including a lens in an optical path of light from the light source,
wherein the lens has a numerical aperture of 0.16 or less, and wherein the light source has a radiation angle sum of 14° or more, the radiation angle sum being a sum of a first radiation angle measured with respect to a first direction and a second radiation angle measured with respect to a second direction orthogonal to the first direction.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

10, 20, 30, 40, 50, 60, 70, 80, 90
100 Light source device
101a First LD (light source)
101b Second LD (light source)
101c Third LD (light source)
102a First lens
102b Second lens
102c Third lens
106a First LCD (liquid crystal element)
106b Second LCD (liquid crystal element)
106c Third LCD (liquid crystal element)
201 MEMS mirror (image forming unit)
202 DMD (image forming unit)
301 Projection lens (projection optical system)
302 Condensing optical element
401 Eyepiece (ocular optical element)
501, 502 Condensing optical element

What is claimed is:

1. A light source device, comprising:
a light source; and
an optical system including a lens in an optical path of light from the light source,
wherein the lens has a numerical aperture of 0.16 or less, and wherein the light source has a radiation angle sum, the radiation angle sum being a sum of a first radiation angle measured with respect to a first direction and a second radiation angle measured with respect to a second direction orthogonal to the first direction.

2. The light source device according to claim 1, wherein the numerical aperture is 0.09 or less, and wherein the radiation angle sum is 14° or more.

3. The light source device according to claim 1, wherein the numerical aperture is 0.16 or less, and wherein the radiation angle sum is 23° or more.

4. The light source device according to claim 1, wherein the numerical aperture is 0.09 or less, and wherein the radiation angle sum is 23° or more.

5. The light source device according to claim 1, wherein the lens is a spherical lens or an aspherical lens.

6. The light source device according to claim 1, wherein the light source comprises a laser.

7. An image display device comprising:
a light source device including:
a light source; and
an optical system including a lens in an optical path of light from the light source,
wherein the lens has a numerical aperture of 0.16 or less, and wherein the light source has a radiation angle sum, the radiation angle sum being a sum of a first radiation angle measured with respect to a first direction and a second radiation angle measured with respect to a second direction orthogonal to the first direction;
an image forming system that forms an image with light from the light source device; and
a projection system that projects the image.

8. The image display device according to claim 7,
wherein the image forming system includes an optical deflector.

9. The image display device according to claim 7,
wherein the image forming system includes a digital mirror device.

10. The image display device according to claim 7,
wherein the image forming system includes a liquid crystal element.

11. The image display device according to claim 7, further comprising:
a plurality of light sources emitting different wavelengths of light; and
a plurality of lenses that correspond to the plurality of light sources,
wherein the optical system combines light from the plurality of light sources that has passed through the corresponding lenses.

12. The image display device according to claim 7, further comprising:
a plurality of light sources emitting different wavelengths of light; and
a plurality of lenses that correspond to the plurality of light sources,
wherein the image forming system includes a plurality of liquid crystal elements that correspond to the plurality of lenses, and
wherein the image forming system causes light passing through the plurality of lenses to be incident on the plurality liquid crystal elements, and combines light that has passed through the liquid crystal elements.

13. The image display device according to claim 7, further comprising an optical element that guides light passing through the projection system to an eyeball of a user.

14. The image display device according to claim 7, further comprising a condensing optical element disposed between the light source device and the image forming system.

15. The image display device according to claim 14, wherein
the image forming system includes a digital mirror device that receives light from the condensing optical element.

16. The image display device according to claim 14, wherein
the image forming system includes an optical deflector that receives light from the condensing optical element.

17. The image display device according to claim 10,
wherein the projection system includes a condensing optical element.

18. The image display device according to claim 17,
wherein the projection system includes a projection optical element, and wherein the condensing optical element is disposed between the image forming system and the projection optical element.

19. The image display device according to claim 17, further comprising:
an optical element that guides light passing through the projection system to an eyeball of a user,
wherein the projection system includes a projection optical element, and
wherein the condensing optical element is disposed between the projection optical element and the optical element.

20. A light source device, comprising:
a light source; and
an optical system including a lens in an optical path of light from the light source,
wherein the lens has a numerical aperture of 0.16 or less, and wherein the light source has a radiation angle sum of 14° or more, the radiation angle sum being a sum of a first radiation angle measured with respect to a first direction and a second radiation angle measured with respect to a second direction orthogonal to the first direction.
